(19) United States
(12) Patent Application Publication
(10) Pub. No.: US 2024/0390841 A1
(43) Pub. Date: Nov. 28, 2024

(54) MIXED GAS SEPARATION APPARATUS, MIXED GAS SEPARATION METHOD, AND MEMBRANE REACTOR

(71) Applicant: NGK INSULATORS, LTD., Nagoya-City (JP)

(72) Inventor: Kenichi NODA, Nagoya-City (JP)

(73) Assignee: NGK INSULATORS, LTD., Nagoya-City (JP)

(21) Appl. No.: 18/792,694

(22) Filed: Aug. 2, 2024

Related U.S. Application Data
(63) Continuation of application No. PCT/JP2022/044182, filed on Nov. 30, 2022.

(30) Foreign Application Priority Data
Feb. 8, 2022 (JP) 2022-017639

(51) Int. Cl. B01D 53/22; B01D 69/10; B01D 71/02

(52) U.S. Cl. CPC B01D 53/228; B01D 69/106; B01D 71/0281

(57) ABSTRACT

Each of first cells has both longitudinal ends open and has an inner surface on which a separation membrane is formed. A second cell has both longitudinal ends closed. A slit extends from an outer surface of the support to the second cell. A sweep gas is supplied to the slit. A/C is greater than or equal to 1 and less than or equal to 50, and B/C is greater than or equal to 0.5 and less than or equal to 20, where A is a sum of cross-sectional areas of every first cell perpendicular to the longitudinal direction, B is a sum of cross-sectional areas of every second cell perpendicular to the longitudinal direction, and C is a sum of opening areas of every slit that is located in one of the longitudinal end portions on the outer surface of the support.

### CROSS-REFERENCE TO RELATED APPLICATIONS

The present application is a continuation application of International Application No. PCT/JP2022/044182 filed on Nov. 30, 2022, which claims priority benefit of Japanese Patent Application No. JP2022-017639 filed in the Japan Patent Office on Feb. 8, 2022. The entire disclosure of which is incorporated herein by reference.

### TECHNICAL FIELD

The present invention relates to a mixed gas separation apparatus, a mixed gas separation method, and a membrane reactor.

### BACKGROUND ART

Various studies and developments are currently underway on processing such as separation or adsorption of specific molecules by using a separation membrane such as a zeolite membrane.

For example, International Publication No. 2016/104048 (Document 1) and International Publication No. 2016/104049 (Document 2) disclose gas separation modules for separating a specific gas from a mixed gas with a gas separation membrane structure in which a gas separation membrane is formed on a porous support. In the gas separation module, the internal space of a housing is separated into two spaces with the plate-like gas separation membrane structure and the mixed gas is supplied into one of the two spaces (i.e., the space on the feed side). Then, the specific gas (hereinafter, referred to as the “to-be-permeated gas”) in the mixed gas permeates the gas separation membrane structure and flows to the other space (i.e., the space on the permeate side) and is separated from the mixed gas. In the case where the concentration of the to-be-permeated gas in the mixed gas is low, in the gas separation module, a sweep gas is flowed into the space on the permeate side so as to lower the partial pressure of the to-be-permeated gas in the space on the permeate side and to accelerate the permeation of the to-be-permeated gas.

As one example of the separation membrane structures for separating the specific gas from the mixed gas, a monolith-type separation membrane complex is known. The separation membrane complex includes a matrix of a plurality of cells arranged therein, each penetrating a column-like porous support in a longitudinal direction, and a separation membrane formed on the inner surfaces of the cells. This increases the area of the separation membrane per unit volume of the separation membrane complex and improves separation performance of the separation membrane complex.

In the case of separating a to-be-permeated gas having a low concentration from a mixed gas by a mixed gas separation apparatus using the monolith-type separation membrane complex described above, it is conceivable to flow a sweep gas into the space outside the column-like porous support. However, the effect of accelerating permeation by the sweep gas is not so much exerted on cells that are distant from the space where the sweep gas flows (e.g., cells that are located in the vicinity of a central portion of the porous support in a section perpendicular to the longitudinal direction), so that there is a limit to improving the separation performance of the mixed gas separation apparatus for a mixed gas.

### SUMMARY OF THE INVENTION

The present invention is intended for a mixed gas separation apparatus, and it is an object of the present invention to improve the performance of separating a mixed gas.

A mixed gas separation apparatus according to one preferable embodiment of the present invention includes a separation membrane complex including a separation membrane and a porous support, and a housing that includes the separation membrane complex. The support has a column-like shape extending in a longitudinal direction. The support includes a plurality of cells arranged in a lengthwise direction and a lateral direction in a matrix. The plurality of cells include a plurality of membrane-formed cells each having both longitudinal ends open and having an inner surface on which the separation membrane is formed, and an exhaust cell having both longitudinal ends closed. The support has longitudinal end portions in both of which a side flow path is formed extending from an outer surface of the support to the exhaust cell. The housing is connected to a mixed gas supplier that supplies a mixed gas containing a plurality of types of gases to the separation membrane complex, a permeated gas collector that collects a permeated gas in the mixed gas, the permeated gas having permeated the separation membrane, a non-permeated gas collector that collects a non-permeated gas in the mixed gas, the non-permeated gas having not permeated the separation membrane, and a sweep gas supplier that supplies a sweep gas. The mixed gas is supplied to one longitudinal end face of the separation membrane complex. The sweep gas is supplied to the side flow path that is open into the outer surface of the support. A/C is greater than or equal to 1 and less than or equal to 50, and B/C is greater than or equal to 0.5 and less than or equal to 20, where A is a sum of cross-sectional areas of every one of the plurality of membrane-formed cells perpendicular to the longitudinal direction, B is a sum of cross-sectional areas of every one of the exhaust cell perpendicular to the longitudinal direction, and C is a sum of opening areas of every one of the side flow path that is located in one of the longitudinal end portions on the outer surface of the support.

The mixed gas separation apparatus achieves improved performance of separating the mixed gas.

Preferably, the support further includes another side flow path extending from the outer surface of the support to the exhaust cell at a longitudinal position different from a longitudinal position of the side flow path. The sweep gas supplied to the side flow path is exhausted through the exhaust cell and the another side flow path to surroundings of the separation membrane complex.

Preferably, the separation membrane complex further includes a covering that is denser than the support and that covers the outer surface of the support between the side flow path and the another side flow path.

Preferably, the every one of the plurality of membrane-formed cells is adjacent to the exhaust cell or the outer surface of the support.

Preferably, the sweep gas contains at least one of water, air, nitrogen, oxygen, and carbon dioxide.

Preferably, the separation membrane is a zeolite membrane.

Preferably, a zeolite constituting the zeolite membrane is composed of an 8- or less-membered ring at the maximum.

Preferably, the mixed gas contains one or more types of substances from among hydrogen, helium, nitrogen, oxygen, water, carbon monoxide, carbon dioxide, nitrogen oxides, ammonia, sulfur oxides, hydrogen sulfide, sulfur fluoride, mercury, arsine, hydrogen cyanide, carbonyl sulfide, C1 to C8 hydrocarbons, organic acids, alcohol, mercaptans, ester, ether, ketone, and aldehyde.

The present invention is also intended for a mixed gas separation method. A mixed gas separation method according to one preferable embodiment of the present invention includes a) preparing a separation membrane complex including a separation membrane and a porous support, and b) supplying a mixed gas containing a plurality of types of gases to the separation membrane and allowing a high-permeability gas in the mixed gas to permeate the separation membrane to separate the high-permeability gas from the mixed gas. The support has a column-like shape extending in a longitudinal direction. The support includes a plurality of cells arranged in a lengthwise direction and a lateral direction in a matrix. The plurality of cells includes a plurality of membrane-formed cells each having both longitudinal ends open and having an inner surface on which the separation membrane is formed, and an exhaust cell having both longitudinal ends closed. The support has longitudinal end portions in both of which a side flow path is formed extending from an outer surface of the support to the exhaust cell. The operation b) includes supplying the mixed gas to one longitudinal end face of the separation membrane complex and supplying a sweep gas to the side flow path that is open into the outer surface of the support. A/C is greater than or equal to 1 and less than or equal to 50, and B/C is greater than or equal to 0.5 and less than or equal to 20, where A is a sum of cross-sectional areas of every one of the plurality of membrane-formed cells perpendicular to the longitudinal direction, B is a sum of cross-sectional areas of every one of the exhaust cell perpendicular to the longitudinal direction, and C is a sum of opening areas of every one of the side flow path that is located in one of the longitudinal end portions on the outer surface of the support.

The present invention is also intended for a membrane reactor. A membrane reactor according to one preferable embodiment of the present invention includes a separation membrane complex including a separation membrane and a porous support, a catalyst that accelerates a chemical reaction of a starting material, and a housing that includes the separation membrane complex and the catalyst. The support has a column-like shape extending in a longitudinal direction. The support includes a plurality of cells arranged in a lengthwise direction and a lateral direction in a matrix. The plurality of cells includes a plurality of membrane-formed cells each having both longitudinal ends open and having an inner surface on which the separation membrane is formed and an exhaust cell having both longitudinal ends closed. The support has longitudinal end portions in both of which a side flow path is formed extending from an outer surface of the support to the exhaust cell. The catalyst is arranged in the plurality of membrane-formed cells of the separation membrane complex. The housing is connected to a source gas supplier that supplies a source gas containing a starting material to the separation membrane complex, a permeated gas collector that collects a permeated gas in a mixed gas, the permeated gas having permeated the separation membrane, the mixed gas being produced by a chemical reaction of the starting material occurring in the presence of the catalyst, a non-permeated gas collector that collects a non-permeated gas in the mixed gas, the non-permeated gas having not permeated the separation membrane, and a sweep gas supplier that supplies a sweep gas. The source gas is supplied to one longitudinal end face of the separation membrane complex. The sweep gas is supplied to the side flow path that is open into the outer surface of the support. A/C is greater than or equal to 1 and less than or equal to 50, and B/C is greater than or equal to 0.5 and less than or equal to 20, where A is a sum of cross-sectional areas of every one of the plurality of membrane-formed cells perpendicular to the longitudinal direction, B is a sum of cross-sectional areas of every one of the exhaust cell perpendicular to the longitudinal direction, and C is a sum of opening areas of every one of the side flow path that is located in one of the longitudinal end portions on the outer surface of the support.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a side view of a separation apparatus according to a first embodiment.

FIG. 2 is a perspective view of a separation membrane complex.

FIG. 3 is a diagram showing one end face of the separation membrane complex.

FIG. 4 is a diagram showing part of a longitudinal section of the separation membrane complex in enlarge dimensions.

FIG. 5 is a diagram showing one end face of the separation membrane complex.

FIG. 6 is a flowchart showing the production of the separation membrane complex.

FIG. 7 is a sectional view of the separation apparatus.

FIG. 8 is a flowchart showing the separation of a mixed gas.

FIG. 9 is a side view of the separation apparatus.

FIG. 10 is a side view of a separation apparatus according to a second embodiment.

FIG. 11 is a sectional view of the separation apparatus.

FIG. 12 is a side view of a mixed gas separation system.

FIG. 13 is a sectional view of a membrane reactor.

FIG. 14 is a diagram showing the method of operating the membrane reactor.

FIG. 15 is a side view of the separation apparatus.

### DETAILED DESCRIPTION

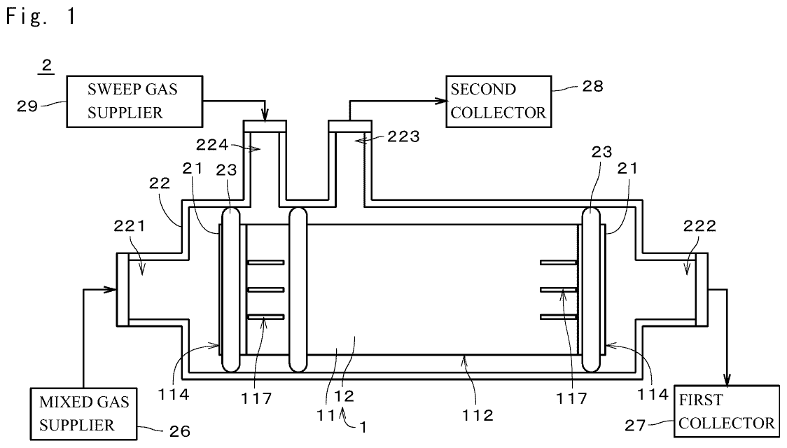

FIG. 1 is a side view showing a mixed gas separation apparatus 2 according to a first embodiment of the present invention. The mixed gas separation apparatus 2 (hereinafter, also simply referred to as the “separation apparatus 2”) is an apparatus for separating a specific type of gas from a mixed gas containing a plurality of types of gases.

The separation apparatus 2 includes a separation membrane complex 1 and a housing 22 that includes the separation membrane complex 1. FIG. 1 gives an illustration of a section of the housing 22 of the separation apparatus 2 and shows an internal configuration of the housing 22. The separation apparatus 2 allows a gas having high permeability in the mixed gas to permeate the separation membrane complex 1 so as to separate the gas from the mixed gas.

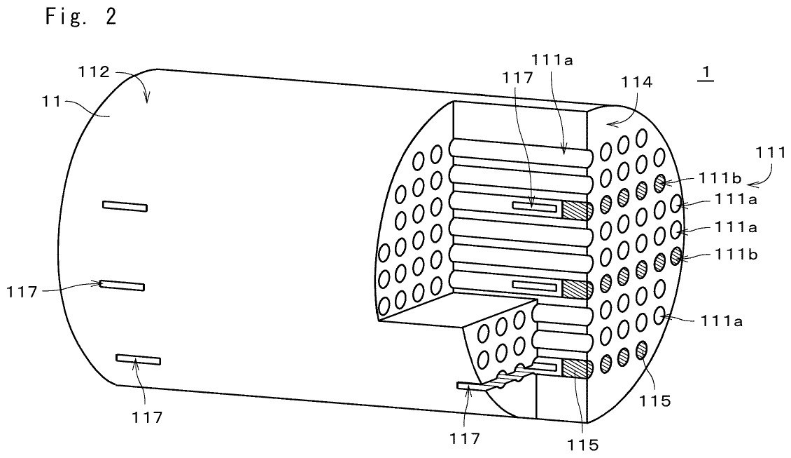

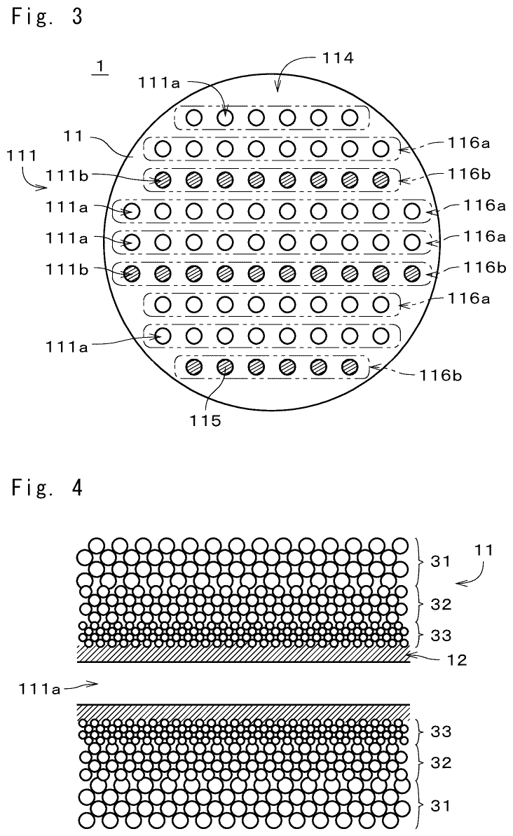

FIG. 2 is a perspective view of the separation membrane complex 1. FIG. 2 also shows part of an internal structure of the separation membrane complex 1. FIG. 3 is a diagram showing one end face 114 in the longitudinal direction of the separation membrane complex 1 (i.e., approximately the right-left direction in FIG. 2). FIG. 4 is a diagram showing part of a longitudinal section of the separation membrane complex 1 in enlarged dimensions and shows the vicinity of one cell 111, which will be described later.

The separation membrane complex 1 includes a porous support 11 and a separation membrane 12 (see FIG. 4) formed on the support 11. In FIG. 4, the separation membrane 12 is cross-hatched. The support 11 is a porous member that is permeable to gas and liquid. In the example shown in FIG. 2, the support 11 is a monolith support that includes an integrally molded column-like body having a plurality of through holes 111 (hereinafter, also referred to as “cells 111”) each extending in the longitudinal direction of the body. In the support 11, the cells 111 are formed (i.e., partitioned) by a porous partition wall. In the example shown in FIG. 2, the support 11 has an approximately column-like outside shape. Each cell 111 may have, for example, an approximately circular sectional shape perpendicular to the longitudinal direction. Note that “approximately circular” denotes a concept that includes not only a perfect circle but also an ellipse or a distorted circle. It is preferable that each cell 111 may have a perfect circular sectional shape, but this sectional shape does not necessarily need to be a perfect circle. In the illustration in FIG. 2, the diameter of the cells 111 is greater than the actual diameter, and the number of cells 111 is smaller than the actual number (the same applies to FIG. 3).

The cells 111 include first cells 111a and second cells 111b. In the example shown in FIGS. 2 and 3, the first cells 111a and the second cells 111b have approximately the same shape. The openings of the second cells 111b are plugged by a plugging member 115 in both longitudinal end faces 114 of the support 11. In other words, the second cells 111b have both longitudinal ends closed. In FIGS. 2 and 3, the plugging member 115 is cross-hatched. Meanwhile, the openings of the first cells 111a are not plugged but open in both of the longitudinal end faces 114 of the support 11.

The aforementioned separation membrane 12 (see FIG. 4) is formed on the inner surface of each first cell 111a having both longitudinal ends open. Preferably, the separation membrane 12 may be formed to cover the entire inner surface of each first cell 111a. That is, the first cells 111a are membrane-formed cells on the inner side of which the separation membrane 12 is formed. In the separation membrane complex 1, the separation membrane 12 is not formed on the inner side of the second cells 111b. As will be described later, the second cells 111b are exhaust cells that are used to exhaust a permeated gas that has permeated the separation membrane 12.

In the example shown in FIGS. 2 and 3, the cells 111 are arranged in the lengthwise direction (i.e., the up-down direction in FIG. 3) and the lateral direction in a matrix in the end faces 114 of the support 11. In the following description, a group of cells 111 that are arranged in a line in the lateral direction (i.e., the right-left direction in FIG. 3) is also referred to as a “cell line.” The cells 111 include a plurality of cell lines aligned in the lengthwise direction. In the example shown in FIG. 3, each cell line is composed of a plurality of first cells 111a or a plurality of second cells 111b.

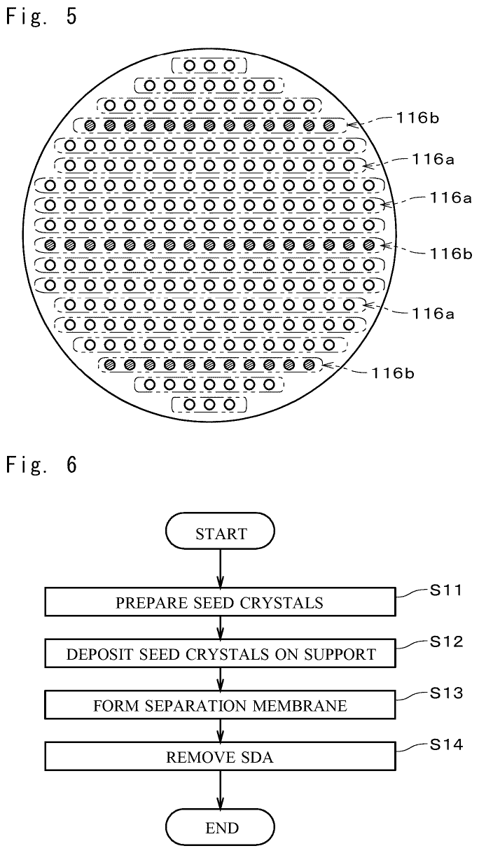

In the example shown in FIG. 3, the cell lines are arranged such that one cell line of second cells 111b (hereinafter, also referred to as a “second cell line 116b”) and two cell lines of first cells 111a (hereinafter, also referred to as “first cell lines 116a”) are alternately arranged adjacent to one another in the lengthwise direction. In FIG. 3, the first cell lines 116a and the second cell lines 116b are each enclosed by a chain double-dashed line (the same applies to FIG. 5, which will be described later). The second cell lines 116b are plugged cell lines having both longitudinal ends plugged.

A plurality of second cells 111b in each second cell line 116b communicate with one another via a slit 117 (see FIG. 2) extending in the lateral direction. The slit 117 extends to an outer surface 112 of the support 11 on both lateral sides of the second cell line 116b, so that the second cells 111b in the second cell line 116b communicate with the space outside the support 11 via the slit 117. In other words, each slit 117 severs as a side flow path that extends from the outer surface of the support 11 to a second cell 111b and extends through the second cell line 116b (i.e., a plurality of second cells 111b aligned in the lateral direction) in the lateral direction to the outer surface of the support 11. In yet other words, each slit 117 connects a plurality of second cells 111b in each second cell line 116b and portions of the outer surface of the support 11 that are on both lateral sides of the second cell line 116b.

For example, each slit 117 may have an approximately rectangular sectional shape perpendicular to the lateral direction. The sectional shape of the slit 117 may be changed to any of various shapes such as a circular shape. Note that this section of the slit 117 is much larger than the sections of the pores of the support 11. For example, the sectional area of each slit 117 perpendicular to the lateral direction may be in the range of 5 to 100 times the sectional area of each second cell 111b perpendicular to the longitudinal direction.

In the separation membrane complex 1, three slits 117 are formed in the vicinity of one longitudinal end portion of the support 11. Since each slit 117 is open into the outer surface of the support 11 on both lateral sides, there are six openings (hereinafter, also referred to as “slit openings”) in the vicinity of the aforementioned end portion of the outer surface of the support 11. In the example shown in FIG. 2, these six slit openings are of approximately the same shape and located at approximately the same longitudinal position. In the separation membrane complex 1, three slits 117 are also formed in the vicinity of the other longitudinal end portion of the support 11 (i.e., at a longitudinal position different from the longitudinal positions of the aforementioned three slits 117), so that there are also six slit openings in the vicinity of the other end portion of the outer surface of the support 11. These six slit openings are also of approximately the same shape and located at approximately the same longitudinal position. In the vicinity of each longitudinal end portion of the support 11, some or all of the slit openings (the aforementioned six slit openings) may differ in shape or position.

The first cell lines 116a are open cell lines having both longitudinal ends open and are also membrane-formed cell lines on the inner side of which the separation membrane 12 is formed (see FIG. 4). Two lines of first cells 111a that are adjacent to one lengthwise side of one second cell line 116b form an open cell line group. In other words, the open cell line group refers to two first cell lines 116a that are sandwiched between two second cell lines 116b that are located in closest proximity to each other in the lengthwise direction.

The number of first cell lines 116a configuring one open cell line group is not limited to two, and may be changed variously. Preferably, the number of first cell lines 116a configuring one open cell line group may be greater than or equal to one and less than or equal to six and more preferably one or two. FIG. 5 shows an example in which five first cell lines 116a configure one open cell line group sandwiched between two second cell lines 116b.

The number of second cell lines 116b is also not limited to three, and may be one or may be two or more. In the separation membrane complex 1, the second cells 111b do not necessarily need to be aligned in the lateral direction, and may be arranged at random intervals. As another alternative, the number of second cells 111b placed in the separation membrane complex 1 may be one.

The support 11 may have a longitudinal length of, for example, 100 mm to 2000 mm. The support 11 may have an outside diameter of, for example, 5 mm to 300 mm. The cell-to-cell distance between each pair of adjacent cells 111 (i.e., the thickness of the support 11 between portions of the adjacent cells 111 that are in closest proximity to each other) may be in the range of, for example, 0.3 mm to 10 mm. Surface roughness (Ra) of the inner surfaces of the first cells 111a of the support 11 may be in the range of, for example, 0.1 μm to 5.0 μm and preferably in the range of 0.2 μm to 2.0 μm. A sectional area of each cell 111 perpendicular to the longitudinal direction may be in the range of, for example, greater than or equal to 2 mm² and less than or equal to 300 mm². In the case where this section of each cell 111 has an approximately circular shape as described above, the diameter of this section may preferably be in the range of 1.6 mm to 20 mm. Note that the shapes and sizes of the support 11 and each cell 111 may be changed variously. For example, the cells 111 may have an approximately polygonal sectional shape perpendicular to the longitudinal direction. The first cells 111a and the second cells 111b may differ in shape and size. Moreover, some or all of the first cells 111a may differ in shape and size, and some or all of the second cells 111b may differ in shape and size.

The material for the support 11 may be any of various substances (e.g., ceramic or metal) as long as this substance has chemical stability in the process of forming the separation membrane 12 on the surface of the support 11. In the present embodiment, the support 11 is formed of a ceramic sintered body. Examples of the ceramic sintered body selected as the material for the support 11 include alumina, silica, mullite, zirconia, titania, yttria, silicon nitride, and silicon carbide. In the present embodiment, the support 11 contains at least one of alumina, silica, and mullite.

The support 11 may contain an inorganic binder for binding aggregate particles of the aforementioned ceramic sintered body. As the inorganic binder, at least one of titania, mullite, easily sinterable alumina, silica, glass frit, clay minerals, and easily sinterable cordierite may be used.

The support 11 may have, for example, a multilayer structure in which a plurality of layers having different mean pore diameters are laminated one above another in the thickness direction in the vicinity of the inner surface of each first cell 111a as an open cell (i.e., in the vicinity of the separation membrane 12). In the example shown in FIG. 4, the support 11 includes a porous base material 31, a porous intermediate layer 32 formed on the base material 31, and a porous surface layer 33 formed on the intermediate layer 32. That is, the surface layer 33 is indirectly formed on the base material 31 via the intermediate layer 32. The intermediate layer 32 is formed between the base material 31 and the surface layer 33. The surface layer 33 configures the inner surface of each first cell 111a of the support 11, and the separation membrane 12 is formed on the surface layer 33. The surface layer 33 may have a thickness of, for example, 1 μm to 100 μm. The intermediate layer 32 may have a thickness of, for example, 100 μm to 500 μm. Note that the intermediate layer 32 and the surface layer 33 may or may not be formed on the inner surface of each second cell 111b. Also, the intermediate layer 32 and the surface layer 33 may or may not be formed on the outer surface 112 and the end faces 114 of the support 11.

The mean pore diameter of the surface layer 33 is smaller than the mean pore diameters of the intermediate layer 32 and the base material 31. The mean pore diameter of the intermediate layer 32 is smaller than the mean pore diameter of the base material 31. The mean pore diameter of the base material 31 may, for example, be greater than or equal to 1 μm and less than or equal to 70 μm. The mean pore diameter of the intermediate layer 32 may, for example be greater than or equal to 0.1 μm and less than or equal to 10 μm. The mean pore diameter of the surface layer 33 may, for example, be greater than or equal to 0.005 μm and less than or equal to 2 μm. The mean pore diameters of the base material 31, the intermediate layer 32, and the surface layer 33 can be measured by, for example, a mercury porosimeter, a perm porometer, or a nano-perm porometer.

The surface layer 33, the intermediate layer 32, and the base material 31 have approximately the same porosity. The porosities of the surface layer 33, the intermediate layer 32, and the base material 31 may, for example, be higher than or equal to 15% and lower than or equal to 70%. The porosities of the surface layer 33, the intermediate layer 32, and the base material 31 can be measured by, for example, the Archimedes method, mercury porosimetry, or image analysis.

The base material 31, the intermediate layer 32, and the surface layer 33 may be formed of the same material, or may be formed of different materials. For example, the base material 31 and the surface layer 33 may contain Al₂O₃ as a chief material. The intermediate layer 32 may contain aggregate particles that contain Al₂O₃ as a chief material, and an inorganic binder that contains TiO₂ as a chief material. In the present embodiment, the aggregate particles of the base material 31, the intermediate layer 32, and the surface layer 33 are substantially formed of only Al₂O₃. The base material 31 may contain an inorganic binder such as glass.

The average particle diameter of the aggregate particles in the surface layer 33 is smaller than the average particle diameter of the aggregate particles in the intermediate layer 32. The average particle diameter of the aggregate particles in the intermediate layer 32 is smaller than the average particle diameter of the aggregate particles in the base material 31. The average particle diameters of the aggregate particles in the base material 31, the intermediate layer 32, and the surface layer 33 can be measured by, for example, a laser diffraction method.

The plugging member 115 may be formed of a material similar to the material(s) for the base material 31, the intermediate layer 32, and the surface layer 33. The porosity of the plugging member 115 may be in the range of, for example, 15% to 70%.

As described above, the separation membrane 12 is formed on the inner surface of each first cell 111a as an open cell (i.e., on the surface layer 33) and covers approximately the entire inner surface. The separation membrane 12 is a porous membrane having microscopic pores. The separation membrane 12 separates a specific substance from a mixture of substances including a plurality of types of substances.

The separation membrane 12 may preferably be an inorganic membrane formed of an inorganic material, may more preferably be any of a zeolite membrane, a silica membrane, a carbon membrane, and a metal-organic framework (MOF) membrane, and may particularly preferably be a zeolite membrane. The zeolite membrane refers to at least a membrane obtained by forming a zeolite in membrane form on the surface of the support 11, and does not include a membrane obtained by just dispersing zeolite particles in an organic membrane. In the present embodiment, the separation membrane 12 is a zeolite membrane. The separation membrane 12 may be a zeolite membrane that contains two or more types of zeolites having different structures or compositions.

The separation membrane 12 may have a thickness of, for example, greater than or equal to 0.05 μm and less than or equal to 50 μm, preferably greater than or equal to 0.1 μm and less than or equal to 20 μm, and more preferably greater than or equal to 0.5 μm and less than or equal to 10 μm. Increasing the thickness of the separation membrane 12 improves separation performance. Reducing the thickness of the separation membrane 12 increases permeance. The surface roughness (Ra) of the separation membrane 12 may, for example, be less than or equal to 5 μm, preferably less than or equal to 2 μm, more preferably less than or equal to 1 μm, and yet more preferably less than or equal to 0.5 μm. The pore diameter of the separation membrane 12 may be in the range of, for example, 0.2 nm to 1 nm. The pore diameter of the separation membrane 12 is smaller than the mean pore diameter in the surface layer 33 of the support 11.

In the case where the zeolite constituting the separation membrane 12 is composed of an n-membered ring at the maximum, the minor axis of the n-membered ring pore is assumed to be the pore diameter of the separation membrane 12. In the case where the zeolite includes a plurality of types of n-membered ring pores where n is the same number, the minor axis of an n-membered ring pore having a largest minor axis is assumed to be the pore diameter of the separation membrane 12. Note that the n-membered ring refers to a ring in which n oxygen atoms compose the framework of each pore and each oxygen atom is bonded to T atoms described later to form a cyclic structure. The n-membered ring also refers to a ring that forms a through hole (channel), and does not include a ring that does not form a through hole. The n-membered ring pore refers to a pore formed of an n-membered ring. From the viewpoint of improving selectivity, it is preferable that the zeolite constituting the zeolite membrane 12 may be composed of an 8- or less-membered ring (e.g., 6- or 8-membered ring) at the maximum.

The pore diameter of the separation membrane 12 is uniquely determined by the framework structure of the zeolite and can be obtained from values disclosed in “Database of Zeolite Structures” [online], by International Zeolite Association, Internet <URL: http://www.iza-structure.org/databases/>.

There are no particular limitations on the type of the zeolite constituting the separation membrane 12, and the zeolite may, for example, be an AEI-, AEN-, AFN-, AFV-, AFX-, BEA-, CHA-, DDR-, ERI-, ETL-, FAU-(X-type, Y-type), GIS-, IHW-, LEV-, LTA-, LTJ-, MEL-, MFI-, MOR-, PAU-, RHO-, SOD-, or SAT-type zeolite. In the case where the zeolite is an 8-membered ring zeolite, the zeolite may, for example, be an AEI-, AFN-, AFV-, AFX-, CHA-, DDR-, ERI-, ETL-, GIS-, IHW-, LEV-, LTA-, LTJ-, RHO-, or SAT-type zeolite. In the present embodiment, the zeolite constituting the separation membrane 12 is a DDR-type zeolite.

The zeolite constituting the separation membrane 12 may contain, for example, at least one of silicon (Si), aluminum (Al), and phosphorus (P) as T atoms (i.e., atoms located in the center of oxygen tetrahedron (TO₄) that constitutes the zeolite). The zeolite constituting the separation membrane 12 may, for example, be a zeolite in which T atoms are composed of only Si or of Si and Al, an AlPO-type zeolite in which T atoms are composed of Al and P, an SAPO-type zeolite in which T atoms are composed of Si, Al, and P, an MAPSO-type zeolite in which T atoms are composed of magnesium (Mg), Si, Al, and P, or a ZnAPSO-type zeolite in which T atoms are composed of zinc (Zn), Si, Al, and P. Some of the T atoms may be replaced by other elements. The zeolite constituting the separation membrane 12 may contain alkali metal. The alkali metal may, for example, be sodium (Na) or potassium (K).

In the case where the zeolite constituting the separation membrane 12 contains Si atoms and Al atoms, the Si/Al ratio in the zeolite of the separation membrane 12 may, for example, be higher than or equal to one and lower than or equal to a hundred thousand. The Si/Al ratio refers to the molar ratio of Si elements to Al elements contained in the zeolite of the separation membrane 12. The Si/Al ratio may preferably be higher than or equal to 5, more preferably higher than or equal to 20, and yet more preferably higher than or equal to 100. It is preferable that the Si/Al ratio is as high as possible because the separation membrane 12 can achieve higher resistance to heat and acids. The Si/Al ratio can be adjusted by adjusting, for example, the compounding ratio of an Si source and an Al source in a starting material solution, which will be described later.

In the case where a difference in the partial pressure of CO₂ between the feed side and the permeate side of the zeolite membrane 12 is 1.5 MPa, CO₂ permeance (permeance) of the zeolite membrane 12 at temperatures of 20° C. to 400° C. may, for example, be higher than or equal to 100 nmol/(m²·sec·Pa), and the ratio between the CO₂ permeance and CH₄ leakage in the zeolite membrane 12 (permeance ratio) at temperatures of 20° C. to 400° C. may, for example, be higher than or equal to 25. In the case where the aforementioned difference in the partial pressure of CO₂ is 0.2 MPa, the aforementioned permeance may, for example, be higher than or equal to 200 nmol/(m2·sec·Pa), and the aforementioned permeance ratio may, for example, be higher than or equal to 60.

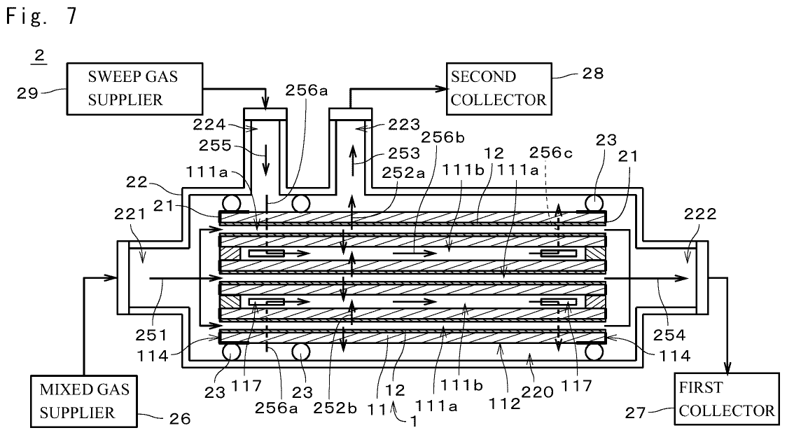

Next, one example of the procedure for producing the separation membrane complex 1 will be described with reference to FIG. 6. In the production of the separation membrane complex 1, firstly, seed crystals used for forming the zeolite membrane 12 are synthesized and prepared (step S11). In the synthesis of the seed crystals, a starting material such as an Si source and a structure-directing agent (hereinafter, also referred to as an “SDA”) or the like are dissolved or dispersed in a solvent so as to prepare a starting material solution of the seed crystals. Then, the starting material solution is subjected to hydrothermal synthesis, and resultant crystals are washed and dried to obtain zeolite powder. The zeolite powder may be used as-is as the seed crystals, or may be subjected to processing such as pulverization to obtain the seed crystals.

Then, a dispersion obtained by dispersing the seed crystals in a solvent (e.g., water) is brought into contact with the inner surfaces of the first cells 111a of the support 11 so as to deposit the seed crystals in the dispersion on the inner surfaces of the first cells 111a (step S12). Note that the seed crystals may be deposited on the inner surfaces of the first cells 111a by any other technique. In step S12, for example, both of the longitudinal end portions of each second cell 111b may be plugged in advance.

Then, the support 11 with the seed crystals deposited thereon is immersed in a starting material solution. The starting material solution may be prepared by dissolving, for example, an Si source and an SDA in a solvent. As the solvent in the starting material solution, for example, water or alcohol such as ethanol may be used. The SDA contained in the starting material solution may, for example, be organic matter. As the SDA, for example, 1-adamantanamine may be used.

Then, the zeolite is grown by hydrothermal synthesis using the aforementioned seed crystals as nuclei, so that the zeolite membrane 12 is formed on the inner surface of each first cell 111a of the support 11 (step S13). Preferably, the temperature during hydrothermal synthesis may be in the range of 120° C. to 200° C. and may, for example, be 160° C. Preferably, the hydrothermal synthesis time may be in the range of 5 hours to 100 hours and may, for example, be 30 hours.

When the hydrothermal synthesis has ended, the support 11 and the zeolite membrane 12 are washed with deionized water. After washing, the support 11 and the zeolite membrane 12 may be dried at, for example, 80° C. After the drying of the support 11 and the zeolite membrane 12, the zeolite membrane 12 is subjected to heat treatment (i.e., firing) so as to almost completely remove the SDA in the zeolite membrane 12 by combustion and to perforate the zeolite membrane 12 with micropores. In this way, the aforementioned separation membrane complex 1 is obtained (step S14).

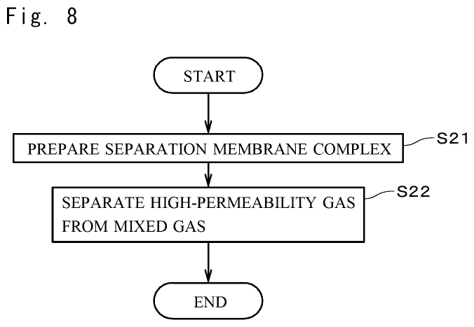

Next, the separation of a mixed gas using the separation membrane complex 1 will be described with reference to FIGS. 1, 7, and 8. FIG. 7 is a sectional view of the separation apparatus 2. To facilitate understanding of the drawing, In FIG. 7, a section of the separation membrane complex 1 is simplified and conceptually shown in FIG. 7. FIG. 8 is a flowchart showing the separation of a mixed gas using the separation apparatus 2.

The separation apparatus 2 supplies a mixed gas containing a plurality of types of gases to the separation membrane complex 1 and allows a gas having high permeability in the mixed gas to permeate the separation membrane complex 1 so as to separate the gas having high permeability from the mixed gas. The separation by the separation apparatus 2 may be conducted for the purpose of extracting a gas having high permeability (hereinafter, also referred to as a “high-permeability gas”) from the mixed gas or for the purpose of condensing a gas having low permeability (hereinafter, also referred to as a “low-permeability gas”).

The mixed gas may contain, for example, one or more types of substances among hydrogen (H₂), helium (He), nitrogen (N₂), oxygen (O₂), water (H₂O), carbon monoxide (CO), carbon dioxide (CO₂), nitrogen oxides, ammonia (NH₃), sulfur oxides, hydrogen sulfide (H₂S), sulfur fluoride, mercury (Hg), arsine (AsH₃), hydrogen cyanide (HCN), carbonyl sulfide (COS), C1 to C8 hydrocarbons, organic acids, alcohol, mercaptans, ester, ether, ketone, and aldehyde. The aforementioned high-permeability gas may, for example, be one or more types of substances among Co₂, NH₃, and H₂O. Note that the mixed gas and the high-permeability gas may be substances other than those described above.

Nitrogen oxides are compounds of nitrogen and oxygen. For example, the aforementioned nitrogen oxides may be substances called NOx such as nitrogen monoxide (NO), nitrogen dioxide (NO₂), nitrous oxide (also referred to as nitrogen monoxide) (N₂O), dinitrogen trioxide (N₂O₃), dinitrogen tetroxide (N₂O₄), or dinitrogen pentoxide (N₂O₅).

Sulfur oxides are compounds of sulfur and oxygen. For example, the aforementioned sulfur oxides may be substances called SOₓ such as sulfur dioxide (SO₂) or sulfur trioxide (SO₃).

Sulfur fluoride is a compound of fluorine and sulfur. For example, the aforementioned sulfur fluoride may be disulfur difluoride (F—S—S—F, S═SF₂), sulfur difluoride (SF₂), sulfur tetrafluoride (SF₄), sulfur hexafluoride (SF₆), or disulfur decafluoride (S₂F₁₀).

C1 to C8 hydrocarbons are hydrocarbons that contain one or more and eight or less carbon atoms. C3 to C8 hydrocarbons each may be any of a linear-chain compound, a side-chain compound, and a cyclic compound. C2 to C8 hydrocarbons each may be either a saturated hydrocarbon (i.e., where double bonds and triple bonds are not located in molecules) or an unsaturated hydrocarbon (i.e., where double bonds and/or triple bonds are located in molecules). C1 to C4 hydrocarbons may, for example, be methane (CH₄), ethane (C₂H₆), ethylene (C₂H₄), propane (C₃H₈), propylene (C₃H₆), normal butane (CH₃(CH₂)₂CH₃), isobutene (CH(CH₃)₃), 1-butene (CH₂═CHCH₂CH₃), 2-butene (CH₃CH═CHCH₃), or isobutene (CH₂═C(CH₃)₂).

The aforementioned organic acids may, for example, be carboxylic acids or sulfonic acids. The carboxylic acids may, for example, be formic acid (CH₂O₂), acetic acid (C₂H₄O₂), oxalic acid (C₂H₂O₄), acrylic acid (C₃H₄O₂), or benzoic acid (C₆H₅COOH). The sulfonic acids may, for example, be ethane sulfonic acid (C₂H₆O₃S). The organic acids may be either chain compounds or cyclic compounds.

The aforementioned alcohol may, for example, be methanol (CH₃OH), ethanol (C₂H₅OH), isopropanol (2-propanol) (CH₃CH(OH)CH₃), ethylene glycol (CH₂(OH)CH₂(OH)), or butanol (C₄H₉OH).

Mercaptans are organic compounds with terminal sulfur hydrides (SH) and are also substances called thiol or thioalcohol. The aforementioned mercaptans may, for example, be methyl mercaptan (CH₃SH), ethyl mercaptan (C₂H₅SH), or 1-propane thiol (C₃H₇SH).

The aforementioned ester may, for example, be formic acid ester or acetic acid ester.

The aforementioned ether may, for example, be dimethyl ether ((CH₃)₂O), methyl ethyl ether (C₂H₅OCH₃), diethyl ether ((C₂H₅)₂O), or tetrahydrofuran ((CH₂)₄O).

The aforementioned ketone may, for example, be acetone ((CH₃)₂CO), methyl ethyl ketone (C₂H₅COCH₃), or diethyl ketone ((C₂H₅)₂CO).

The aforementioned aldehyde may, for example, be acetaldehyde (CH₃CHO), propionaldehyde (C₂H₅CHO), or butanal (butyraldehyde) (C₃H₇CHO).

As shown in FIGS. 1 and 7, the separation apparatus 2 includes the separation membrane complex 1, a sealer 21, the housing 22, and three seal members 23. The separation membrane complex 1, the sealer 21, and the seal members 23 are placed in the housing 22. In FIG. 7, the separation membrane 12 of the separation membrane complex 1 is cross-hatched. The internal space of the housing 22 is an enclosed space isolated from the space around the housing 22. The housing 22 is connected to a mixed gas supplier 26, a first collector 27, a second collector 28, and a sweep gas supplier 29.

The sealer 21 is a member that is attached to both ends in the longitudinal direction of the support 11 (i.e., the left-right direction in FIG. 7) and covers and seals both of the longitudinal end faces 114 of the support 11 and part of the outer surface 112 in the vicinity of both of the end faces 114. The sealer 21 prevents the inflow and outflow of gas from both of the end faces 114 of the support 11. For example, the sealer 21 may be a sealing layer made of glass or a resin. In the present embodiment, the sealer 21 is a glass seal having a thickness of 10 μm to 50 μm. The material and shape of the sealer 21 may be changed as appropriate. Note that the sealer 21 has a plurality of openings that overlap the plurality of first cells 111a of the support 11, so that both longitudinal ends of each first cell 111a are not covered with the sealer 21. This allows the inflow and outflow of fluid from both of the longitudinal ends of each first cell 111a into and out of the first cell 111a.

The housing 22 is an approximately cylindrical tube-like member. For example, the housing 22 may be made of stainless steel or carbon steel. The longitudinal direction of the housing 22 is approximately parallel to the longitudinal direction of the separation membrane complex 1. One longitudinal end of the housing 22 (i.e., the end on the left side in FIG. 7) is provided with a first supply port 221, and the other longitudinal end thereof is provided with a first exhaust port 222. The first supply port 221 is connected to the mixed gas supplier 26. The first exhaust port 222 is connected to the first collector 27.

The housing 22 has a second exhaust port 223 and a second supply port 224 on its side. In the example shown in FIG. 7, the second exhaust port 223 is arranged in the vicinity of the longitudinal central portion of the housing 22, and the second supply port 224 is arranged between the second exhaust port 223 and the first supply port 221 in the longitudinal direction of the housing 22. The second supply port 224 is located at approximately the same longitudinal position as the slits 117 that are located in the vicinity of one longitudinal end portion of the separation membrane complex 1. The second exhaust port 223 and the second supply port 224 may be arranged at the same circumferential position about the central axis of the separation membrane complex 1 (i.e., a virtual straight line extending in the longitudinal direction through the centers of the end faces 114 of the separation membrane complex 1), or may be arranged at different circumferential positions. The second exhaust port 223 is connected to the second collector 28. The second supply port 224 is connected to the sweep gas supplier 29. Note that the shape and material of the housing 22 may be changed in various ways.

The three seal members 23 are placed alongside in the longitudinal direction between the outer surface 112 of the separation membrane complex 1 and the inner surface of the housing 22. Each seal member 23 is an approximately circular ring-shaped member formed of a material that is impermeable to gas and liquid. The seal members 23 may, for example, be O-rings or packing materials formed of a resin having flexibility. The seal members 23 are in tight connect with the outer surface 112 of the separation membrane complex 1 and the inner surface of the housing 22 along the entire circumference in the circumferential direction about the aforementioned central axis of the separation membrane complex 1 (hereinafter, also simply referred to as the “circumferential direction”). Note that the material of the seal members 23 may be carbon, metal, or any other inorganic material other than a resin.

Among the three seal members 23, the two seal members 23 that are located at both longitudinal ends are placed along the entire circumference of the separation membrane complex 1 in the vicinity of both of the longitudinal end portions of the separation membrane complex 1. In each longitudinal end portion of the separation membrane complex 1, the seal member 23 is located between the slits 117 and the end face 114 of the separation membrane complex 1 in the longitudinal direction. Among the three seal members 23, the seal member 23 that is located between the aforementioned two seal members 23 is located between the second supply port 224 and the second exhaust port 223 in the longitudinal direction. This seal member 23 is also located between the second exhaust port 223 and the slits 117 that are located at approximately the same position as the second supply port 224 in the longitudinal direction.

In the example shown in FIG. 7, among the three seal members 23, the two seal members 23 at both of the longitudinal ends are each in tight contact with the outer surface of the sealer 21 between the slits 117 and the longitudinal end face 114 of the support 11 and are indirectly in tight contact with the outer surface 112 of the separation membrane complex 1 via the sealer 21. Among the three seal members 23, the remaining one seal member 23 is directly in tight contact with the outer surface 112 of the separation membrane complex 1 at a position between the slits 117 and the second exhaust port 223 in the longitudinal direction. The space between each seal member 23 and the outer surface 112 of the separation membrane complex 1 and the space between each seal member 23 and the inner surface of the housing 22 are sealed so as to substantially disable the gas permeation.

The mixed gas supplier 26 supplies a mixed gas into the internal space of the housing 22 via the first supply port 221. For example, the mixed gas supplier 26 may include a pressure mechanism such as a blower or a pump that sends the mixed gas toward the housing 22 under pressure. The pressure mechanism may include, for example, a temperature controller and a pressure regulator that respectively adjust the temperature and pressure of the mixed gas supplied to the housing 22. The first collector 27 and the second collector 28 may include, for example a reservoir that stores the gas derived from the housing 22, or a blower or a pump that transfers the derived gas. The sweep gas supplier 29 supplies a sweep gas into the internal space of the housing 22 via the second supply port 224. For example, the sweep gas supplier 29 may include a pressure mechanism such as a blower or a pump that sends the sweep gas toward the housing 22 under pressure.

In the separation of the mixed gas, firstly, the separation membrane complex 1 is prepared (step S21 in FIG. 8). Specifically, the separation membrane complex 1 is attached to the inside of the housing 22. Then, the mixed gas supplier 26 supplies a mixed gas containing a plurality of types of gases with different permeability through the separation membrane 12, into the housing 22 (specifically, the space on the left side of the left end face 114 of the separation membrane complex 1) as indicated by an arrow 251 in FIG. 7. For example, the mixed gas may be composed primarily of CO₂ and CH₄. The mixed gas may further contain a gas other than CO₂ and CH₄. The pressure of the mixed gas supplied from the mixed gas supplier 26 into the housing 22 (i.e., initial pressure) may be in the range of, for example, 0.1 MPa to 20.0 MPa. The temperature of the mixed gas supplied from the mixed gas supplier 26 may be in the range of, for example, 10° C. to 250° C.

In the separation apparatus 2, the sweep gas supplier 29 supplies a sweep gas, which is used for separating the mixed gas, into the housing 22 as indicated by an arrow 255, in parallel with the mixed gas supplier 26 supplying the mixed gas to the separation membrane complex 1. Specifically, the space into which the sweep gas is supplied is an approximately cylindrical space that is located outward of the outer surface 112 of the separation membrane complex 1 in the radial direction (i.e., the radial direction about the aforementioned central axis), and is also a space between the first and second seal members 23 from the left among the three seal members 23 in FIG. 7. The sweep gas may be any of various gases. The sweep gas may be a gas composed of a single component, or may be a mixed gas containing a plurality of types of gases. For example, the sweep gas may contain at least one of H₂O, air, N₂, O₂, and CO₂. The sweep gas may be a substance other than the aforementioned substances.

The sweep gas supplied from the sweep gas supplier 29 into the housing 22 flows through each slit 117 located between the first and second seal members 23 from the left side in FIG. 7 and flows into the second cells 111b penetrated by the slits 117 as indicated by arrows 256a. In each second cell 111b, the sweep gas flows toward the right in FIG. 7 as indicated by arrows 256b. This sweep gas flows through each slit 117 located between the first and second seal members 23 from the right side in FIG. 7 and flows to a separation space 220 around the separation membrane complex 1 as indicated by arrows 256c. The separation space 220 is an approximately cylindrical space that is located radially outward of the outer surface 112 of the separation membrane complex 1 (i.e., around the separation membrane complex 1) and is also a space between the first and second seal members 23 from the right side among the three seal members 23. Part of the sweep gas flowing through the second cells 111b also flows from the second cells 111b into the surrounding pores of the support 11 and flows through the support 11 to the separation space 220 from the outer surface 112 of the support 11 and the other second cells 111b.

Meanwhile, the mixed gas supplied from the mixed gas supplier 26 into the housing 22 flows into each first cell 111a of the separation membrane complex 1. As indicated by arrows 252a, a gas having high permeability in the mixed gas, i.e., a high-permeability gas, permeates the separation membrane 12 and the support 11 from the first cells 111a and is derived to the separation space 220 from the outer surface 112 of the separation membrane complex 1. The high-permeability gas having permeated the separation membrane 12 and the support 11 from the first cells 111a and flowed into the second cells 111b flows through the second cells 111b toward the right together with the sweep gas as indicated by the arrows 256b and flows to the separation space 220 through each slit 117 located between the first and second seal members 23 from the right side in FIG. 7 as indicated by the arrows 256c. Note that the high-permeability gas flowing from the first cells 111a into the second cells 111b may permeate the support 11 and be derived to the separation space 220 without passing through the slits 117.

In the separation membrane complex 1, the sweep gas flows toward the separation space 220 through the second cells 111b and through the pores of the support 11 as described above. In other words, the sweep gas flows around and in the vicinity of the first cells 111a toward the separation space 220 and flows around the outer surface 112 of the support 11. Accordingly, the high-permeability gas that has permeated the separation membrane 12 from the first cells 111a is carried by the sweep gas and speedily derived to the separation space 220. This lowers the partial pressure of the high-permeability gas on the permeate side of the separation membrane 12 (i.e., on the side opposite to the internal spaces of the first cells 111a) and accelerates the flow of the high-permeability gas from the feed side of the separation membrane 12 (i.e., the internal spaces of the first cells 111a) to the permeate side.

As a result of the high-permeability gas (e.g., CO₂) permeating the separation membrane 12 and being derived to the separation space 220 as described above, the high-permeability gas is separated from other substances such as a low-permeability gas (e.g., CH₄) in the mixed gas (step S22). As described above, the separation apparatus 2 accelerates the separation of the high-permeability gas from the mixed gas because the sweep gas flowing in the vicinity of the first cells 111a accelerates the permeation of the high-permeability gas through the separation membrane 12.

Here, A is assumed to be a sum of cross-sectional areas of every first cell 111a perpendicular to the longitudinal direction, B is assumed to be a sum of cross-sectional areas of every second cell 111b perpendicular to the longitudinal direction, and C is assumed to be a sum of slit opening areas of every slit 117 that is located in one longitudinal end portion (in the present embodiment, a sum of the areas of the six slit openings in the vicinity of the aforementioned one longitudinal end portion on the outer surface 112 of the support 11). A, B, and C are assumed to be expressed in the same unit. In this case, A/C is greater than or equal to 1 and less than or equal to 50, and B/C is greater than or equal to 0.5 and less than or equal to 20. When A/C is greater than or equal to 1 and less than or equal to 50, it is possible to supply the sweep gas without any surplus or shortage to the separation membrane 12 formed on the first cells 111a. When B/C is greater than or equal to 0.5 and less than or equal to 20, it is possible to pass the sweep gas through the second cells 111b while maintaining low pressure loss.

As described above, the number of first cell lines 116a configuring one open cell line group that is sandwiched between two second cell lines 116b that are located in closest proximity to each other in the lengthwise direction may preferably be greater than or equal to one and less than or equal to six, and may more preferably be one or two. When the number of first cell lines 116a configuring one open cell line group is greater than or equal to one and less than or equal to six, it is possible to efficiently supply the sweep gas to the vicinity of each first cell 111a (i.e., the vicinity of the separation membrane 12).

When the number of first cell lines 116a configuring one open cell line group is one or two, every first cell 111a is adjacent to a second cell 111b or the outer surface 112 of the support 11. Accordingly, it is possible to more efficiently supply the sweep gas to the vicinity of each first cell 111a (i.e., the vicinity of the separation membrane 12). As a result, the permeation of the high-permeability gas through the separation membrane 12 is further accelerated. Here, “every first cell 11a is adjacent to a second cell 111b” denotes that the first cell 111a is arranged in the vicinity of the second cell 111b without sandwiching any other first cell 111a between the second cell 111b and itself. Also, “every first cell 111a is adjacent to the outer surface 112 of the support 11” denotes that the first cell 111a is arranged in the vicinity of the outer surface 112 without sandwiching any other first cell 111a between the outer surface 112 and itself.

As described above, since the end faces 114 of the support 11 are covered with the sealer 21, the separation membrane complex 1 prevents or inhibits the mixed gas containing a low-permeability gas from entering the inside of the support 11 through the end faces 114 and entering the separation space 220 without permeating the separation membrane 12. The gas derived to the separation space 220 (hereinafter, referred to as the “permeated gas”) is guided to and collected by the second collector 28 via the second exhaust port 223 as indicated by an arrow 253 in FIG. 7. The second collector 28 serves as a permeated gas collector that collects the permeated gas having permeated the separation membrane 12 in the mixed gas. The permeated gas may include a low-permeability gas that has permeated the separation membrane 12, in addition to the aforementioned high-permeability gas.

In the mixed gas, a gas excluding the gas that has permeated the separation membrane 12 and the support 11 (hereinafter, referred to as a “non-permeated gas”) flows from the left side to the right side in FIG. 7 through the first cells 111a and is guided to and collected by the first collector 27 via the first exhaust port 222 as indicated by an arrow 254. The first collector 27 serves as a non-permeated gas collector that collects a non-permeated gas that has not permeated the separation membrane 12 in the mixed gas. The non-permeated gas collected by the first collector 27 may include a high-permeability gas that has not permeated the separation membrane 12, in addition to the aforementioned low-permeability gas. For example, the non-permeated gas collected by the first collector 27 may be circulated to the mixed gas supplier 26 and supplied again into the housing 22.

In the following description, the upstream side of the flow of the mixed gas and the non-permeated gas in the first cells 111a, i.e., the left side in FIG. 7, is also simply referred to as the “upstream side.” The downstream side of the flow of the mixed gas and the non-permeated gas in the first cells 111a, i.e., the right side in FIG. 7, is also simply referred to as the “downstream side.” In the separation apparatus 2 shown in FIG. 7, the sweep gas is supplied to the slits 117 that are the three side flow paths on the upstream side of the separation membrane complex 1, flows from the upstream side to the downstream side in the second cells 111b, and is exhausted to the separation space 220 through the three slits 117 on the downstream side of the separation membrane complex 1 (i.e., the other three side flow paths). That is, the direction of the flow of the sweep gas in the second cells 111b is the same as the direction of the flow of the mixed gas and the non-permeated gas in the first cells 111a. In this way, the sweep gas is supplied from the upstream side on which the partial pressure of the high-permeability gas in the mixed gas is relatively high. This favorably accelerates the permeation of the high-permeability gas on the upstream side and to increase the amount of the high-permeability gas permeating the separation membrane 12.

In the separation membrane complex 1, the number, shape, and arrangement of the slits 117 may be modified in various ways. For example, the slits 117 do not necessarily need to be open into the outer surface 112 of the support 11 on both lateral sides of the second cell lines 116b, and may be open into the outer surface 112 of the support 11 only on one lateral side of the second cell line 116b. That is, a configuration may be adopted in which the slits 117 extend from the outer surface 112 of the support 11 to the second cells 111b.

The slits 117 do not necessarily need to be formed in each second cell line 116b, and the slits 117 may be formed to penetrate only some of the second cell lines 116b. In other words, the separation membrane complex 1 may include second cell lines 116b that do not communicate with one another with the slits 117.

The slits 117 do not necessarily need to be formed on the upstream and downstream sides of the separation membrane complex 1 and, for example, the slits 117 on the downstream side may be omitted. In this case, the sweep gas supplied to the slits 117 on the upstream side flows from the upstream side to the downstream side through the second cells 111b and is derived together with the permeated gas to the separation space 220 through the pores of the support 11.

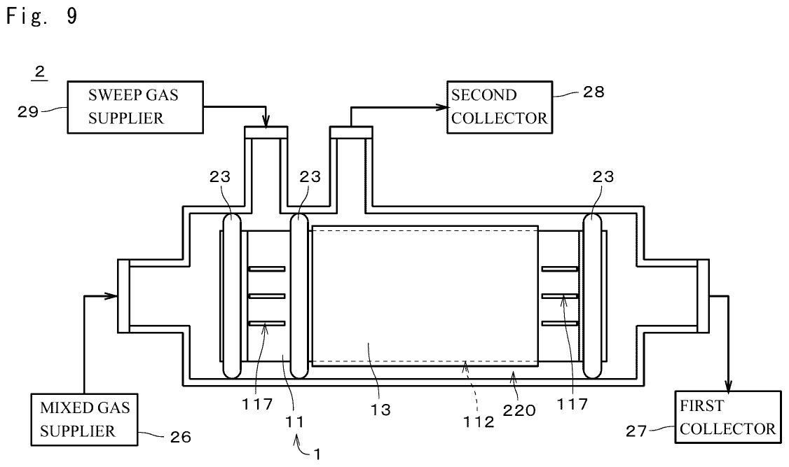

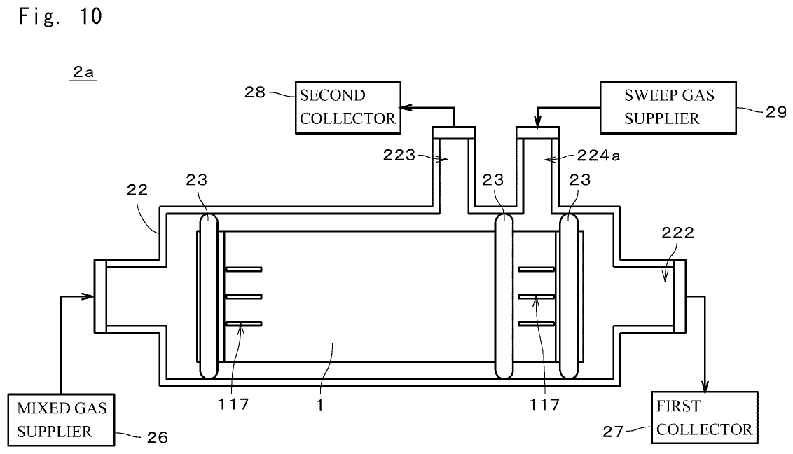

As shown in FIG. 9, the separation apparatus 2 may further include a covering 13 that covers the outer surface 112 of the support 11. The covering 13 is an approximately cylindrical membranous portion or a thin plate-like portion that is in direct contact with the entire circumference of the outer surface 112 of the support 11 in the circumferential direction. The covering 13 is a layer that is denser than the support 11. For example, the covering 13 may be a non-porous member with substantially no pores. The covering 13 is placed between the upstream slits 117 and the downstream slits 117. In the example shown in FIG. 9, the covering 13 is placed between the downstream slits 117 and the seal member 23 that is located in the middle in the longitudinal direction among the three seal members 23, and covers the entire outer surface 112 of the support 11 along approximately the entire length between the above seal member 23 and the above slits 117.

The covering 13 may be formed of, for example, glass, ceramic, metal, or a resin. The covering 13 may, for example, be a glass membrane formed by firing on the surface of the support 11. For example, the covering 13 may be formed by depositing glass frit on the surface of the support 11 and firing the glass frit together with the support 11. The formation of the covering 13 may be conducted in parallel with the formation of the separation membrane 12 (see FIG. 7), or may be conducted before or after the formation of the separation membrane 12. Note that the material and shape of the covering 13 may be changed as appropriate. For example, the covering 13 may be formed of a resinous adhesive tape that is wound around the outer surface 112 of the support 11. Alternatively, the covering 13 may be a porous member with pores having a smaller mean pore diameter than the support 11.

In this way, when the separation apparatus 2 includes the covering 13 that covers the outer surface 112 of the support 11 in the separation space 220, it is possible to reduce the possibility that the sweep gas flowing from the upstream slits 117 to the downstream slits 117 through the second cells 111b (see FIG. 7) may pass through the pores of the support 11 before reaching the downstream slits 117 and flow out from the outer surface 112 to the separation space 220. This increases the amount of the sweep gas flowing in the longitudinal direction along the first cells 111a (see FIG. 7) and accordingly further accelerates the flow of the high-permeability gas from the feed side of the separation membrane 12 to the permeate side.

As described above, the separation apparatus 2 includes the separation membrane complex 1 and the housing 22. The separation membrane complex 1 includes the separation membrane 12 and the porous support 11. The housing 22 includes the separation membrane complex 1. The support 11 is a column-like member extending in the longitudinal direction. The support 11 includes a plurality of cells 111 arranged in the lengthwise direction and the lateral direction in a matrix. The cells 111 include a plurality of membrane-formed cells (i.e., the first cells 111a) and an exhaust cell (i.e., the second cells 111b). Each of the first cells 111a has both longitudinal ends open. Each of the first cells 111a has an inner surface on which the separation membrane 12 is formed. Each second cell 111b has both longitudinal ends closed. The support 11 has longitudinal end portions in both of which side flow paths (i.e., the slits 117) are formed extending from the outer surface 112 of the support 11 to the second cells 111b.

The housing 22 is connected to the mixed gas supplier 26, the permeated gas collector (i.e., the second collector 28), the non-permeated gas collector (i.e., the first collector 27), and the sweep gas supplier 29. The mixed gas supplier 26 supplies a mixed gas containing a plurality of types of gases to the separation membrane complex 1. The second collector 28 collects the permeated gas having permeated the separation membrane 12 in the mixed gas. The first collector 27 collects the non-permeated gas having not permeated the separation membrane 12 in the mixed gas. The sweep gas supplier 29 supplies the sweep gas. The mixed gas is supplied to one longitudinal end face 114 of the separation membrane complex 1. The sweep gas is supplied to the slits 117 that are open into the outer surface 112 of the support 11.

Then, A/C is greater than or equal to 1 and less than or equal to 50, and B/C is greater than or equal to 0.5 and less than equal to 20, where A is the sum of the cross-sectional areas of every first cell 111a perpendicular to the longitudinal direction, B is the sum of the cross-sectional areas of every second cell 111b perpendicular to the longitudinal direction, and C is the sum of the opening areas of every slit 117 that is located in one longitudinal end portion. Accordingly, as described above, it is possible to efficiently supply the sweep gas to the vicinity of each first cell 111a (i.e., the vicinity of the separation membrane 12) around the plurality of first cells 111a. This accelerates the flow of the high-permeability gas from the feed side of the separation membrane 12 to the permeate side and improves the separation performance of the separation apparatus 2 for the mixed gas. Therefore, even if the high-permeability gas in the mixed gas sent from the mixed gas supplier 26 to the housing 22 has a relatively low partial pressure, it is possible to favorably separate the high-permeability gas from the mixed gas.

As described above, it is preferable that the support 11 may further include another side flow path (e.g., the downstream slits 117) extending from the outer surface 112 of the support 11 to the second cells 111b at a different longitudinal position from the longitudinal position of the aforementioned side flow path (e.g., the upstream slits 117). Then, it is preferable that the sweep gas supplied to the slits 117 may pass through the second cells 111b and the other slits 117 and may be exhausted to the surroundings of the separation membrane complex 1. This increases the amount of the sweep gas flowing through the second cells 111b between the slits 117 and the other slits 117. In this way, by increasing the amount of the sweep gas flowing in the longitudinal direction along the first cells 111a, it is possible to further accelerate the flow of the high-permeability gas from the feed side of the separation membrane 12 to the permeate side. As a result, it is possible to further improve the separation performance of the separation apparatus 2 for the mixed gas.

More preferably, the separation membrane complex 1 may further include the covering 13 that is denser than the support 11 and that covers the outer surface 112 of the support 11 between the aforementioned slits 117 and the other slits 117. This further increases the amount of the sweep gas flowing in the longitudinal direction along the first cells 111a as described above and yet further accelerates the flow of the high-permeability gas from the feed side of the separation membrane 12 to the permeate side. As a result, it is possible to yet further improve the separation performance of the separation apparatus 2 for the mixed gas.

As described above, it is preferable that every first cell 111a may be adjacent to the outer surface 112 of the support 11 or a second cell 111b. By so doing, it is possible to more efficiently supply the sweep gas to the vicinity of each first cell 111a (i.e., the vicinity of the separation membrane 12) around the first cells 111a. This further accelerates the flow of the high-permeability gas from the feed side of the separation membrane 12 to the permeate side and to further improve the separation performance of the separation apparatus 2 for the mixed gas.

As described above, it is preferable that the sweep gas may contain at least one of H₂O, air, N₂, O₂, and CO₂. If such a gas that can be processed relatively easily is used as the sweep gas, it becomes easy to process the sweep gas and the permeated gas collected by the second collector 28 (e.g., disposal of the collected gas or the separation of the high-permeability gas and the sweep gas).

As described above, it is preferable that the separation membrane 12 may be a zeolite membrane. The separation membrane 12 composed of zeolite crystals having a uniform pore diameter favorably achieves selective permeation of a high-permeability gas. As a result, it is possible to efficiently separate a high-permeability gas from the mixed gas.

More preferably, it is preferable that the zeolite constituting the zeolite membrane may be composed of an 8- or less-membered ring at the maximum. This more favorably achieves selective permeation of a high-permeability gas such as CO₂ that has a relatively small molecular size. As a result, it is possible to more efficiently separate a high-permeability gas from the mixed gas.

The separation apparatus 2 described above is particularly suitable for use in cases where the mixed gas contains at least one or more types of substances among hydrogen, helium, nitrogen, oxygen, water, carbon monoxide, carbon dioxide, nitrogen oxides, ammonia, sulfur oxides, hydrogen sulfide, sulfur fluoride, mercury, arsine, hydrogen cyanide, carbonyl sulfide, C1 to C8 hydrocarbons, organic acids, alcohol, mercaptans, ester, ether, ketone, and aldehyde.

The mixed gas separation method described above includes the step of preparing the separation membrane complex 1 including the separation membrane 12 and the porous support 11 (step S21) and the step of supplying a mixed gas containing a plurality of types of gases to the separation membrane 12 and allowing a high-permeability gas in the mixed gas to permeate the separation membrane 12 to separate the high-permeability gas from the mixed gas (step S22). The support 11 has a column-like shape extending in the longitudinal direction. The support 11 includes a plurality of cells 111 arranged in the lengthwise direction and the lateral direction in a matrix. The cells 111 include a plurality of membrane-formed cells (i.e., the first cells 111a) and an exhaust cell (i.e., a second cell 111b). Each of the first cells 111a has both longitudinal ends open. The separation membrane 12 is formed on the inner surface of each of the first cells 111a. Each second cell 111b has both longitudinal ends closed. The support 11 has longitudinal end portions in both of which a side flow path (i.e., the slits 117) is formed extending from the outer surface 112 of the support 11 to the second cell 111b. In step S22, the mixed gas is supplied to one longitudinal end face of the separation membrane complex 1, and the sweep gas is supplied to the slits 117 that are open into the outer surface 112 of the support 11.

Then, A/C is greater than or equal to 1 and less than or equal to 50, and B/C is greater than or equal to 0.5 and less than or equal to 20, where A is the sum of the cross-sectional areas of every first cell 111a perpendicular to the longitudinal direction, B is the sum of the cross-sectional areas of every second cell 111b perpendicular to the longitudinal direction, and C is the sum of the opening areas of every slit 117 that is located in one longitudinal end portion on the outer surface 112 of the support 11. Accordingly, as described above, it is possible to efficiently supply the sweep gas to the vicinity of each first cell 111a (i.e., the vicinity of the separation membrane 12) around the first cells 111a. This accelerates the flow of the high-permeability gas from the feed side of the separation membrane 12 to the permeate side and accelerates the separation of the mixed gas.

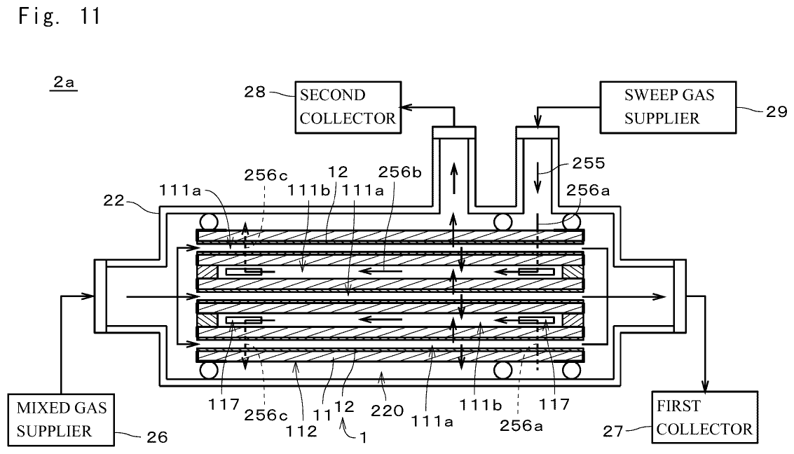

Next, a mixed gas separation apparatus 2a according to a second embodiment of the present invention will be described with reference to FIG. 10. FIG. 10 is a side view of the mixed gas separation apparatus 2a (hereinafter, also simply referred to as the “separation apparatus 2a”). The structure of the separation apparatus 2a is approximately similar to the structure of the separation apparatus 2, except that a second supply port 224a is arranged at a different position from the second supply port 224 of the separation apparatus 2 shown in FIG. 1 and that the three seal members 23 are placed differently from those of the separation apparatus 2. In the following description, constituent elements of the separation apparatus 2a that correspond to those of the separation apparatus 2 are given the same reference signs.

As shown in FIG. 10, the second supply port 224a is arranged between the first exhaust port 222 and the second exhaust port 223 in the longitudinal direction of the housing 22. In the example shown in FIG. 10, the second supply port 224a is located at approximately the same longitudinal position as the three downstream slits 117 of the separation membrane complex 1. The second supply port 224a may be arranged at the same circumferential position as the second exhaust port 223, or may be arranged at a different circumferential position. The second supply port 224a is connected to the sweep gas supplier 29.

Among the three seal members 23, the positions of the two seal members 23 that are located at both longitudinal ends are the same as those in the aforementioned separation apparatus 2. Among the three seal members 23, the seal member 23 that is located between the above two seal members 23 is located in the longitudinal direction between the second exhaust port 223 and the second supply port 224a. This seal member 23 is also located in the longitudinal direction between the second exhaust port 223 and the slits 117 that are located at approximately the same position as the second supply port 224a.

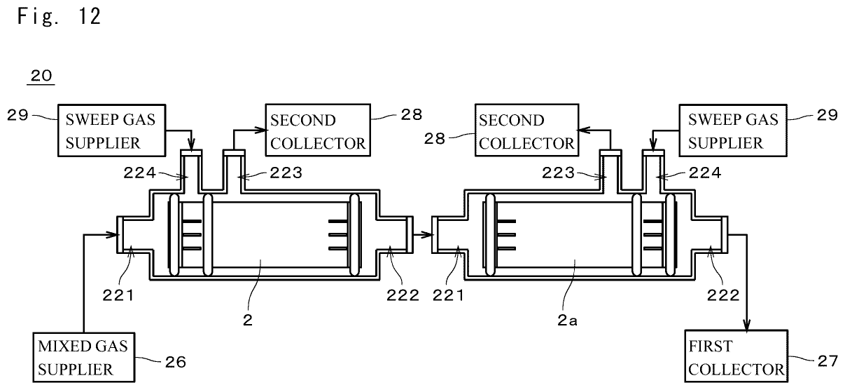

FIG. 11 is a sectional view of the separation apparatus 2a. In the separation apparatus 2a, the sweep gas supplier 29 supplies the aforementioned sweep gas into the housing 22 as indicated by the arrow 255, in parallel with the mixed gas supplier 26 supplying the mixed gas to the separation membrane complex 1. Specifically, the space into which the sweep gas is supplied is an approximately cylindrical space that is located radially outward of the outer surface 112 of the separation membrane complex 1 and is also a space between the first and second seal members 23 from the right side among the three seal members 23 in FIG. 11.

The sweep gas supplied from the sweep gas supplier 29 into the housing 22 flows into the second cells 111b through the downstream slits 117 of the separation membrane complex 1 as indicated by the arrows 256a. In each second cell 111b, the sweep gas flows toward the left in FIG. 11 (i.e., from the downstream side to the upstream side) as indicated by the arrows 256b. This sweep gas flows through the upstream slits 117 of the separation membrane complex 1 to the separation space 220 around the separation membrane complex 1 as indicated by the arrows 256c. The separation space 220 is an approximately cylindrical space that is located radially outward of the outer surface 112 of the separation membrane complex 1 (i.e., around the separation membrane complex 1) and is also a space between the first and second seal members 23 from the left side among the three seal members 23 in FIG. 11. The sweep gas flowing through the second cells 111b also flows from the second cells 111b into the surrounding pores of the support 11 and flows through the support 11 to the separation space 220 from the outer surface 112 of the support 11.

In the separation apparatus 2a, as in the aforementioned separation apparatus 2, the sweep gas flows toward the separation space 220 around and in the vicinity of the first cells 111a. This lowers the partial pressure of a high-permeability gas on the permeate side of the separation membrane 12 (i.e., on the side opposite to the internal space of the first cells 111a) and accordingly accelerates the flow of the high-permeability gas from the feed side of the separation membrane 12 (i.e., the internal space of the first cells 111a) to the permeate side. As a result, it is possible to improve the separation performance of the separation apparatus 2a for the mixed gas. Accordingly, even if the high-permeability gas in the mixed gas sent from the mixed gas supplier 26 to the housing 22 has a relatively low partial pressure, it is possible to favorably separate the high-permeability gas from the mixed gas.

In the separation apparatus 2a, the sweep gas is supplied to the three downstream side flow paths, i.e., the downstream slits 117, of the separation membrane complex 1, flows through the second cells 111b from the downstream side to the upstream side, and is exhausted to the separation space 220 through the three upstream slits 117 (i.e., the other three side flow paths). That is, the direction of flow of the sweep gas in the second cells 111b is opposite to the directions of flow of the mixed gas and the non-permeated gas in the first cells 111a. In this way, if the sweep gas is supplied from the downstream side on which the high-permeability gas in the mixed gas has a relatively low partial pressure, it is possible to allow the separation membrane 12 to favorably function even on the downstream side and to increase the amount of the high-permeability gas permeating the separation membrane 12.

Like the separation apparatus 2, the separation apparatus 2a may further include the aforementioned covering 13 (see FIG. 9) that covers the outer surface 112 of the support 11. In the case where the covering 13 is placed in the separation apparatus 2a shown in FIG. 10, the covering 13 is placed between the upstream slits 117 and the seal member 23 that is located in the middle in the longitudinal direction among the three seal members 23, and covers the entire outer surface 112 of the support 11 along approximately the overall length between the above seal member 23 and the above slits 117. This further increases the amount of the sweep gas flowing in the longitudinal direction along the first cells 111a and accordingly further improves the separation performance of the separation apparatus 2a for the mixed gas as described above.

In the above description, the separation apparatuses 2 and 2a are both arranged singly between the mixed gas supplier 26 and the first collector 27. However, for example, a plurality of separation apparatuses 2 may be connected in series between the mixed gas supplier 26 and the first collector 27, or a plurality of separation apparatuses 2a may be connected in series between the mixed gas supplier 26 and the first collector 27. As another alternative one or more separation apparatuses 2 and one or more separation apparatuses 2a may be connected in series between the mixed gas supplier 26 and the first collector 27. In this case, the order of arrangement of the separation apparatuses 2 and the separation apparatuses 2a may be determined as appropriate.

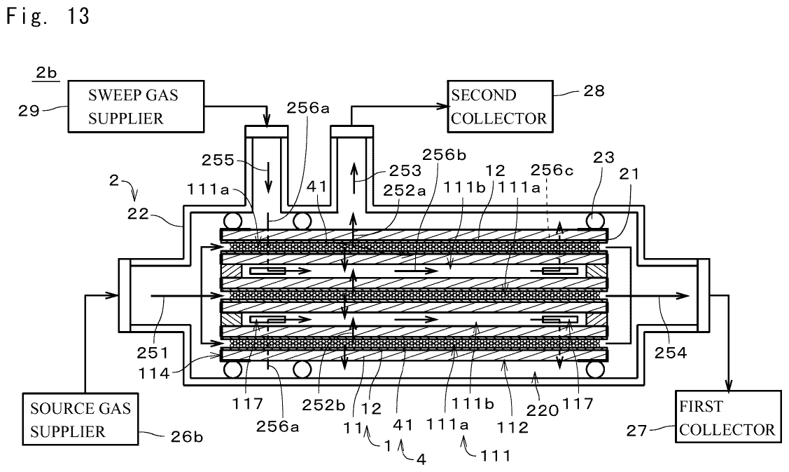

In a mixed gas separation system 20 shown in FIG. 12, one separation apparatus 2 and one separation apparatus 2a are connected in series between the mixed gas supplier 26 and the first collector 27. Specifically, the separation apparatus 2a is series-connected downstream of the separation apparatus 2. The first supply port 221 of the separation apparatus 2 is connected to the mixed gas supplier 26, and the first exhaust port 222 of the separation apparatus 2 is connected to the first supply port 221 of the separation apparatus 2a. The first exhaust port 222 of the separation apparatus 2a is connected to the first collector 27. The second exhaust ports 223 of the separation apparatuses 2 and 2a are connected to the second collectors 28, and the second supply ports 224 of the separation apparatuses 2 and 2a are connected to the sweep gas suppliers 29.

In the separation apparatus 2 located on the upstream side, the direction of flow of the sweep gas in the second cells 111b (see FIG. 7) is approximately the same as the directions of flow of the mixed gas and the non-permeated gas in the first cells 111a (see FIG. 7). This favorably accelerates the permeation of the high-permeability gas on the upstream side of the separation apparatus 2 and increases the amount of the high-permeability gas permeating the separation membrane 12 as described above. In the separation apparatus 2a located on the downstream side, the direction of flow of the sweep gas in the second cells 111b (see FIG. 11) is opposite to the directions of flow of the mixed gas and the non-permeated gas in the first cells 111a (see FIG. 11). This allows the separation membrane 12 to favorably function even on the downstream side of the separation apparatus 2a and increases the amount of the high-permeability gas permeating the separation membrane 12 as described above. As a result, it is possible to improve the separation performance of the mixed gas separation system 20.

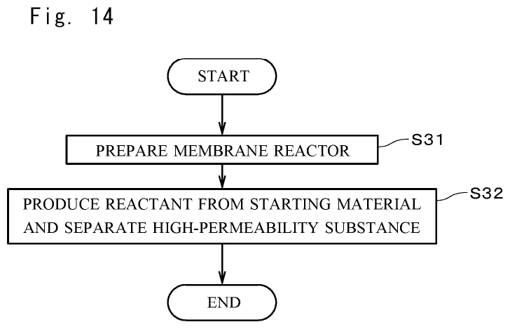

Next, membrane reactor apparatus 2b according to a third embodiment of the present invention will be described with reference to FIG. 13. FIG. 13 is a sectional view of the membrane reactor apparatus 2b. The membrane reactor apparatus 2b includes the separation apparatus 2 shown in FIG. 1 and catalysts 41 kept in the separation membrane complex 1 of the separation apparatus 2. In the following description, the separation membrane complex 1 and the catalyst 41 are also collectively referred to as a “membrane reactor 4.” To facilitate understanding of the drawing, FIG. 13 conceptually shows a section of the membrane reactor 4 in a simplified manner. Constituent elements of the membrane reactor apparatus 2b that correspond to those of the separation apparatus 2 are given the same reference signs.

In the membrane reactor apparatus 2b, a large number of catalysts 41 are arranged in the first cells 111a of the separation membrane complex 1. The catalysts 41 may have any of various shapes. Examples of the shape of the catalysts 41 include a spherical shape, an ellipsoidal shape, a cylinder-like shape (e.g., a circular cylinder-like shape, a prismatic shape, an oblique circular cylinder-like shape, or an oblique prismatic shape), and a conical shape (e.g., a circular conical shape or a pyramidal shape). In the present embodiment, the catalysts 41 have an approximately spherical shape. The catalysts 41 are particles having smaller particle diameters than the first cells 111a as viewed in the longitudinal direction of the separation membrane complex 1. The catalysts 41 are a substance that accelerates chemical reactions of a starting material. In other words, chemical reactions of the starting material are accelerated in the presence of the catalysts 41. As the catalysts 41, commonly known catalysts suitable for each reaction may be used and, for example, zirconia-supported nickel catalysts for methanation (i.e., catalysts with nickel (Ni) supported on stabilized zirconia) may be used. The type of the catalysts 41 is not limited to this example and may be changed variously. Note that the catalysts 41 are not provided in the second cells 111b.

In the membrane reactor apparatus 2b, one or both longitudinal end portions of the first cells 111a are stuffed with a filling that does not plug the openings of the first cells 111a in order to prevent or inhibit coming off of the particles of the catalysts 41 from the inside of the first cells 111a. For example, the filling may be made of a soft material such as heat-resistant wool and partly blocks the openings of the first cells 111a while substantially not inhibiting the passage of gas.

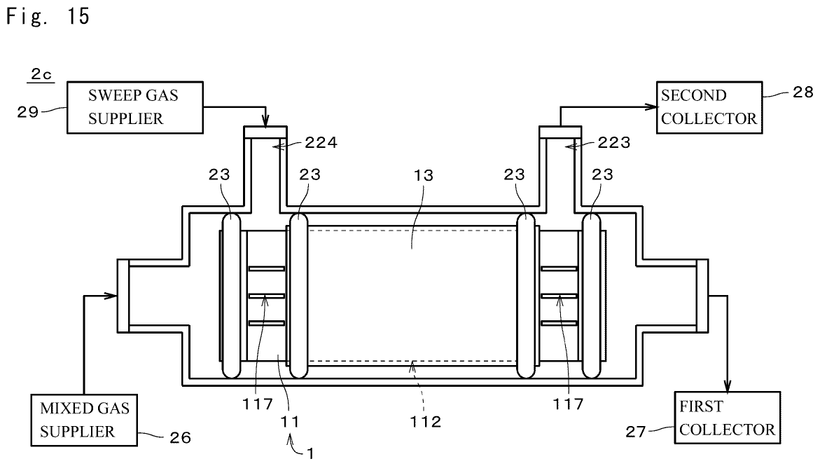

Next, a method of operating the membrane reactor apparatus 2b will be described with reference to FIG. 14. FIG. 14 is a flowchart showing the operation of the membrane reactor apparatus 2b. The following description is given on the assumption that methanation (i.e., a reaction for producing CH₄ from H₂ and CO₂) is performed in the membrane reactor apparatus 2b.

In the operation of the membrane reactor apparatus 2b, firstly, the membrane reactor 4 (i.e., the separation membrane complex 1 and the catalysts 41) is prepared (step S31). Specifically, the membrane reactor 4 is attached to the inside of the housing 22. Then, a source gas supplier 26b supplies a source gas containing a starting material (i.e., CO₂ and H₂) into the housing 22 (specifically, the space on the left side of the left end face 114 of the separation membrane complex 1) as indicated by the arrow 251. The source gas may contain a gas other than the starting material. In the membrane reactor apparatus 2b, the interior of the housing 22 is preheated, and the temperature of the membrane reactor 4 is raised up to a temperature suitable for each chemical reaction of the starting material (e.g., a temperature of 150° C. to 500° C.). The membrane reactor 4 is maintained at this temperature during the chemical reaction of the starting material.

The sweep gas supplier 29 supplies the aforementioned sweep gas into the housing 22 as indicated by the arrow 255. The sweep gas flows through each upstream slit 117 into the second cells 111b as indicated by the arrows 256a and flows toward the right in FIG. 13 through the second cells 111b as indicated by the arrows 256b. The sweep gas flows to the separation space 220 through each downstream slit 117 as indicated by the arrows 256c. The sweep gas flowing through the second cells 111b also flows from the second cells 111b into the surrounding pores of the support 11 and flows through the support 11 to the separation space 220 from the outer surface 112 of the support 11.

The source gas supplied from the source gas supplier 26b to the housing 22 flows into each first cell 111a of the separation membrane complex 1. In each first cell 111a, the starting material reacts chemically in the presence of the catalysts 41 so as to produce a mixed gas containing reactants (i.e., CH₄ and H₂O). As indicated by the arrows 252a, a high-permeability gas (i.e., H₂O) in the mixed gas permeates the separation membrane 12 and the support 11 from the first cells 111a and is derived to the separation space 220 from the outer surface 112 of the separation membrane complex 1. The high-permeability gas having penetrated the separation membrane 12 and the support 11 from the first cells 111a and flowed into the second cells 111b, as indicated by the arrows 252b, flows toward the right together with the sweep gas flowing rightward through the second cells 111b as indicated by the arrows 256b and flows to the separation space 220 through each downstream slit 117 as indicated by arrows 256c. Note that the high-permeability gas flowing from the first cells 111a into the second cells 111b may permeate the support 11 and may be guided to the separation space 220 without passing through the slits 117. The permeated gas derived to the separation space 220 is guided to and collected by the second collector 28 as indicated by the arrow 253 in FIG. 13. The permeated gas may further include the source gas or a low-permeability gas (i.e., CH₄) that has permeated the separation membrane 12, in addition to the aforementioned high-permeability gas.

In the separation membrane complex 1, as described above, the sweep gas flows toward the separation space 220 through the second cells 111b and through the pores of the support 11. In other words, the sweep gas flows toward the separation space 220 around and in the vicinity of the first cells 111a. Accordingly, the high-permeability gas (i.e., H₂O) that has permeated the separation membrane 12 from the first cells 111a is carried by the sweep gas and speedily derived to the separation space 220. This lowers the partial pressure of the high-permeability gas on the permeate side of the separation membrane 12 and accelerates the flow of the high-permeability gas from the feed side of the separation membrane 12 to the permeate side. As a result, it is possible to accelerate the separation of the high-permeability gas from the mixed gas in the first cells 111a and to accelerate the chemical reaction of the starting material in the first cells 111a (step S32).

In the membrane reactor apparatus 2b, a non-permeated gas in the mixed gas, excluding the permeated gas, flows from the left side to the right side in FIG. 13 through the first cells 111a and is guided to and collected by the first collector 27 as indicated by the arrow 254. The non-permeated gas may include a high-permeability gas that has not permeated the separation membrane 12, in addition to the aforementioned low-permeability gas. For example, the non-permeated gas collected by the first collector 27 may be circulated to the source gas supplier 26b and supplied again into the housing 22.

As described above, the membrane reactor apparatus 2b includes the separation membrane complex 1, the catalysts 41, and the housing 22. The separation membrane complex 1 includes the separation membrane 12 and the porous support 11. The catalysts 41 accelerate chemical reactions of a starting material. The housing 22 includes the separation membrane complex 1 and the catalysts 41. The support 11 has a column-like shape extending in the longitudinal direction. The support 11 includes a plurality of cells 111 arranged in the lengthwise direction and the lateral direction in a matrix. The cells 111 include a plurality of membrane-formed cells (i.e., the first cells 111a) and an exhaust cell (i.e., the second cell 111b). Each of the first cells 111a has longitudinal ends open. Each of the first cells 111a also has an inner surface on which the separation membrane 12 is formed. Each second cell 111b has longitudinal ends closed. The support 11 has longitudinal end portions in both of which the side flow paths (i.e., the slits 117) are formed extending from the outer surface 112 of the support 11 to the second cells 111b. The catalysts 41 are arranged in the first cells 111a of the separation membrane complex 1.

The housing 22 is connected to the source gas supplier 26b, the permeated gas collector (i.e., the second collector 28), the non-permeated gas collector (i.e., the first collector 27), and the sweep gas supplier 29. The source gas supplier 26b supplies a source gas containing a starting material to the separation membrane complex 1. The second collector 28 collects a permeated gas that has permeated the separation membrane 12 in a mixed gas produced by a chemical reaction of the starting material in the presence of the catalysts 41. The first collector 27 collects a non-permeated gas that has not permeated the separation membrane 12 in the mixed gas. The sweep gas supplier 29 supplies a sweep gas. The source gas is supplied to one longitudinal end face 114 of the separation membrane complex 1. The sweep gas is supplied to the slits 117 that are open into the outer surface 112 of the support 11.

Then, A/C is greater than or equal to 1 and less than or equal to 50, and B/C is greater than or equal to 0.5 and less than or equal to 20, where A is a sum of the cross-sectional areas of every first cell 111a perpendicular to the longitudinal direction, B is a sum of the cross-sectional areas of every second cell 111b perpendicular to the longitudinal direction, and C is a sum of the opening areas of every slit 117 that is located in one longitudinal end portion on the outer surface 112 of the support 11. Accordingly, as described above, it is possible to efficiently supply the sweep gas to the vicinity of each first cell 111a (i.e., the vicinity of the separation membrane 12) around the first cells 111a. This accelerates the flow of the high-permeability gas from the feed side of the separation membrane 12 to the permeate side and accelerates the chemical reaction of the starting material in the membrane reactor apparatus 2b.

Next, performance of separation membrane complexes 1 in Samples 1 to 6 will be described with reference to Table 1. Samples 2 to 4 are examples of the present invention, and Samples 1, 5, and 6 are comparative examples.

TABLE 1

| | | | Pressure | Sweep-Gas |
|---|---|---|---|---|
| Sample | | | Loss | Sufficiently Rate |
| Number | A/C | B/C | (kPa) | (%) |
| 1 | 0.8 | 0.4 | — | — |
| 2 | 1.1 | 0.5 | 0.2 | 100 |
| 3 | 7.9 | 1.6 | 2.3 | 80 |
| 4 | 48.2 | 9.6 | 98.8 | 64 |
| 5 | 48.5 | 24.3 | 157.4 | 69 |
| 6 | 67.0 | 33.5 | 302.0 | 40 |

In Samples 1 to 6 shown in Table 1, a monolith support 11 made of alumina and having an outside diameter of 180 mm and a length of 1000 mm was prepared by a method similar to that disclosed in the example of International Publication No. 2010/134514, the disclosure of which is herein incorporated by reference. At this time, the number of first cell line 116a and the length and width of the slit openings were adjusted to obtain the supports 11 each having A/C and B/C shown for Samples 1 to 6. Note that the slits 117 of the same shape were formed in the vicinity of both longitudinal end portions of those supports 11.

Then, using a production method similar to the method including steps S11 to S13 described above, a DDR-type zeolite membrane (i.e., the separation membrane 12) was synthesized on the inside of the first cells 111a of the supports 11 according to Samples 2 to 6 to obtain the separation membrane complexes 1. In the production of these supports 11, step S14 (the removal of the SDA) was not performed in order to accurately measure pressure loss described later. That is, the measurement of the pressure loss described later was made using the DDR-type zeolite membrane through which the gas did not permeate.

For the support 11 in Sample 1, A/C was 0.8, and B/C was 0.4. The support 11 in Sample 1, in which A/C was less than 1, could not be used for the synthesis of the DDR-type zeolite membrane due to its large slit openings and low strength.

Next, as shown in FIG. 9, a resinous adhesive tape (i.e., the covering 13) was wound around the outer surfaces of the supports 11 of the separation membrane complex 1 in each of Samples 2 to 6 so as to attach the support 11 to the inside of the housing 22. With the second collector 28 open to the atmosphere, the pressure loss was measured by introducing a certain amount of nitrogen gas from the sweep gas supplier 29 and measuring a difference in pressure between the sweep gas supplier 29 and the second collector 28. Also, with the second collector 28 open to the atmosphere, a nitrogen gas was introduced at a pressure of 500 kPa from the sweep gas supplier 29 to measure the amount of nitrogen gas collected by the second collector 28 (i.e., the amount of collected gas). In Samples 2 to 6, the value obtained by dividing the amount of collected gas by the membranous area of the DDR-type zeolite membrane was assumed to be a sweep-gas sufficiency rate (%), and the sweep-gas sufficiency rate in Sample 2 was defined as 100% to obtain the sweep-gas sufficiency rates for the other samples.

For the support 11 in Sample 2, A/C was 1.1, and B/C was 0.5. The pressure loss was 0.2 kPa, and the sweep-gas sufficiency rate was 100% as described above. For the support 11 in Sample 3, A/C was 7.9, and B/C was 1.6. The pressure loss was 2.3 kPa, and the sweep-gas sufficiency rate was 80%. For the support 11 in Sample 4, A/C was 48.2, and B/C was 9.6. The pressure loss was 98.8 kPa, and the sweep-gas sufficiency rate was 64%.

For the support 11 in Sample 5, A/C was 48.5, and B/C was 24.3. The pressure loss was 157.4 kPa, and the sweep-gas sufficiency rate was 69%. For the support 11 in Sample 6, A/C was 67.0, and B/C was 33.5. The pressure loss was 302.0 kPa, and the sweep-gas sufficiency rate was 40%.

When Samples 2 to 4 are compared with Samples 5 and 6, in Samples 2 to 4 in each of which B/C was greater than or equal to 0.5 and less than or equal to 20, the values for the pressure loss were less than or equal to 100 kPa and small. In Samples 2 to 5 in each of which A/C was greater than 1 and less than 50, the sweep-gas sufficiency rates were higher than or equal to 60%. In this way, in Samples 2 to 4 in each of which A/C was greater than or equal to 1 and less than or equal to 50 and B/C was greater than or equal to 0.5 and less than or equal to 20, it is possible to flow a sufficient amount of sweep gas to the membranous area while keeping the pressure loss small. Therefore, the permeation of a to-be-permeated gas can be accelerated more efficiently if the separation of the mixed gas is achieved by flowing the sweep gas in the separation apparatus 2 using the separation membrane complex 1 that includes the separation membrane 12 (e.g., the DDR-type zeolite membrane produced by a production method similar to the method including steps S11 to S14 described above) formed on the support 11 in any of Samples 2 to 4.

When the pressure loss for Samples 2 to 6 was measured in the same manner as described above while the resinous adhesive tape (i.e., the covering 13) wound around the separation membrane complex 1 was removed as in FIG. 1, the values for the pressure loss showed a similar tendency to that shown in Table 1, but it was found that part of the nitrogen gas flowed through the pores of the support 11 to the second collector 28 without passing through the second cells 111b. In this way, the presence of the covering 13 on the outer surface of the support 11 helps increasing the amount of sweep gas flowing in the longitudinal direction along the first cells 111a.

Moreover, when the pressure loss was measured in the same manner as described above while the resinous adhesive tape was wound around only the end portions of the separation membrane complexes 1 in Samples 2 to 6 that are far from the sweep gas supplier 29 and that include the slits 117, it was confirmed that the values for the pressure loss became greater than those shown in Table 1. In this way, the presence of the slits 117 in the vicinity of the longitudinal end portions of the support 11 helps passing the sweep gas through the second cells 111b while keeping the pressure loss small.

As described above, when A/C is greater than or equal to 1 and less than or equal to 50 and B/C is greater than 0.5 and less than or equal to 20, the separation membrane complex 1 can achieve improved separation performance for the mixed gas. The separation performance for the mixed gas can be further improved by, for example, providing the slits 117 in the longitudinal end portions of the support 11 or covering the outer surface of the support 11 with the dense covering 13.

The separation apparatuses 2 and 2a, the mixed gas separation method, and the membrane reactor apparatus 2b described above may be modified in various ways.

For example, as in the separation apparatus 2c shown in FIG. 15, the longitudinal length of the covering 13 may be changed from that of the covering 13 of the separation apparatus 2 shown in FIG. 9. In the example shown in FIG. 15, the upstream edge of the covering 13 is located in the vicinity of the upstream slits 117. In this case, the seal member 23 that is located in close proximity to the upstream slits 117 on the downstream side of the second supply port 224 connected to the sweep gas supplier 29 is in indirect contact with the outer surface 112 of the support 11 via the covering 13.

As shown in FIG. 15, the second exhaust port 223 connected to the second collector 28 may be provided at approximately the same longitudinal position as the downstream slits 117. The separation apparatus 2c may further include another seal member 23 that is located in close proximity to the downstream slits 117 on the upstream side of the second exhaust port 223. In this case, this seal member 23 is in indirect contact with the outer surface 112 of the support 11 via the covering 13. In the separation apparatus 2c, almost the whole amount of the permeated gas having permeated the separation membrane 12 (see FIG. 7) flows into the second cells 111b (see FIG. 7) and is collected by the second collector 28 while passing through the downstream slits 117 together with the sweep gas. In the separation apparatus 2c, approximately the entire outer surface 112 of the support 11 is covered by the covering 13 in a region that is sandwiched between two seal members 23 excluding those located at both longitudinal ends among the four seal members 23. Therefore, in this region, the permeated gas and the sweep gas are substantially not derived to the surroundings of the separation membrane complex 1 from the outer surface 112 of the support 11. In the separation apparatus 2c, the positions of the second collector 28 and the sweep gas supplier 29 may be reversed.

In the separation membrane complex 1 of the separation apparatus 2 shown in FIG. 7, the zeolite constituting the separation membrane 12, which is a zeolite membrane, may be composed of a more than 8-membered ring at the maximum. The separation membrane 12 is not limited to a zeolite membrane, and may be an inorganic membrane such as a silica membrane or a carbon membrane, or may be an organic membrane such as a polyimide membrane or a silicone membrane. The separation membrane complex 1 may further include a functional membrane or a protection membrane that is laminated on the separation membrane 12, in addition to the separation membrane 12. Such a functional membrane or a protection membrane may be a zeolite membrane, or may be an inorganic membrane other than a zeolite membrane or an organic membrane. The same applies to the separation apparatuses 2a and 2c and the membrane reactor apparatus 2b.

Among the three seal members 23 of the separation apparatus 2 shown in FIG. 7, one seal member 23 other than those located at the longitudinal ends may allow the passage of a small amount of gas between the seal member 23 and the outer surface 112 of the separation membrane complex 1 and between the seal member 23 and the inner surface of the housing 22.

In the membrane reactor apparatus 2b, chemical reactions other than methanation may occur. Examples of the chemical reactions include a reverse shift reaction, a methanol synthesis reaction, and a Fischer-Tropsch synthesis.

The configurations of the above-described preferred embodiment and variations may be appropriately combined as long as there are no mutual inconsistencies.

While the invention has been shown and described in detail, the foregoing description is in all aspects illustrative and not restrictive. It is therefore understood that numerous modifications and variations can be devised without departing from the scope of the invention.

### INDUSTRIAL APPLICABILITY

The separation apparatus according to the present invention may, for example, be usable for the separation of a variety of mixed gases. The membrane reactor apparatus according to the present invention is usable for producing various reactants from various starting materials by chemical reactions in the presence of catalysts.

### REFERENCE SIGNS LIST

1 separation membrane complex
2, 2a, 2c separation apparatus
2b membrane reactor apparatus
11 support
12 separation membrane
13 covering
22 housing
26 mixed gas supplier
26b source gas supplier
27 first collector
28 second collector
29 sweep gas supplier
41 catalyst
111 cell
111a first cell
111b second cell
112 outer surface
114 end face
117 slit
S11 to S14, S21 to S22, S31 to S32 step

1. A mixed gas separation apparatus comprising:
a separation membrane complex including a separation membrane and a porous support; and
a housing that includes said separation membrane complex,
wherein said support has a column-like shape extending in a longitudinal direction,
said support includes a plurality of cells arranged in a lengthwise direction and a lateral direction in a matrix,
said plurality of cells include:
a plurality of membrane-formed cells each having both longitudinal ends open and having an inner surface on which said separation membrane is formed; and
an exhaust cell having both longitudinal ends closed,
said support has longitudinal end portions in both of which a side flow path is formed extending from an outer surface of said support to said exhaust cell,
said housing is connected to:
a mixed gas supplier that supplies a mixed gas containing a plurality of types of gases to said separation membrane complex;
a permeated gas collector that collects a permeated gas in said mixed gas, the permeated gas having permeated said separation membrane;
a non-permeated gas collector that collects a non-permeated gas in said mixed gas, the non-permeated gas having not permeated said separation membrane; and
a sweep gas supplier that supplies a sweep gas,
said mixed gas is supplied to one longitudinal end face of said separation membrane complex,
said sweep gas is supplied to said side flow path that is open into the outer surface of said support, and
A/C is greater than or equal to 1 and less than or equal to 50, and B/C is greater than or equal to 0.5 and less than or equal to 20,
where A is a sum of cross-sectional areas of every one of said plurality of membrane-formed cells perpendicular to the longitudinal direction;
B is a sum of cross-sectional areas of every one of said exhaust cell perpendicular to the longitudinal direction; and
C is a sum of opening areas of every one of said side flow path that is located in one of the longitudinal end portions on the outer surface of said support.

2. The mixed gas separation apparatus according to claim 1, wherein
said support further includes another side flow path extending from the outer surface of said support to said exhaust cell at a longitudinal position different from a longitudinal position of said side flow path, and
said sweep gas supplied to said side flow path is exhausted through said exhaust cell and said another side flow path to surroundings of said separation membrane complex.

3. The mixed gas separation apparatus according to claim 2, wherein
said separation membrane complex further includes a covering that is denser than said support and that covers the outer surface of said support between said side flow path and said another side flow path.

4. The mixed gas separation apparatus according to claim 1, wherein
said every one of said plurality of membrane-formed cells is adjacent to said exhaust cell or the outer surface of said support.

5. The mixed gas separation apparatus according to claim 1, wherein
said sweep gas contains at least one of water, air, nitrogen, oxygen, and carbon dioxide.

6. The mixed gas separation apparatus according to claim 1, wherein
said separation membrane is a zeolite membrane.

7. The mixed gas separation apparatus according to claim 6, wherein
a zeolite constituting said zeolite membrane is composed of an 8- or less-membered ring at the maximum.

8. The mixed gas separation apparatus according to claim 1, wherein
said mixed gas contains one or more types of substances from among hydrogen, helium, nitrogen, oxygen, water, carbon monoxide, carbon dioxide, nitrogen oxides, ammonia, sulfur oxides, hydrogen sulfide, sulfur fluoride, mercury, arsine, hydrogen cyanide, carbonyl sulfide, C1 to C8 hydrocarbons, organic acids, alcohol, mercaptans, ester, ether, ketone, and aldehyde.

9. A mixed gas separation method comprising:
a) preparing a separation membrane complex including a separation membrane and a porous support; and
b) supplying a mixed gas containing a plurality of types of gases to said separation membrane and allowing a high-permeability gas in said mixed gas to permeate said separation membrane to separate said high-permeability gas from said mixed gas,
wherein said support has a column-like shape extending in a longitudinal direction,
said support includes a plurality of cells arranged in a lengthwise direction and a lateral direction in a matrix,
said plurality of cells includes:
a plurality of membrane-formed cells each having both longitudinal ends open and having an inner surface on which said separation membrane is formed; and
an exhaust cell having both longitudinal ends closed,
said support has longitudinal end portions in both of which a side flow path is formed extending from an outer surface of said support to said exhaust cell,
said operation b) includes supplying said mixed gas to one longitudinal end face of said separation membrane complex and supplying a sweep gas to said side flow path that is open into the outer surface of said support, and
A/C is greater than or equal to 1 and less than or equal to 50, and B/C is greater than or equal to 0.5 and less than or equal to 20,
where A is a sum of cross-sectional areas of every one of said plurality of membrane-formed cells perpendicular to the longitudinal direction;
B is a sum of cross-sectional areas of every one of said exhaust cell perpendicular to the longitudinal direction; and
C is a sum of opening areas of every one of said side flow path that is located in one of the longitudinal end portions on the outer surface of said support.

10. A membrane reactor comprising:
a separation membrane complex including a separation membrane and a porous support;
a catalyst that accelerates a chemical reaction of a starting material; and
a housing that includes said separation membrane complex and said catalyst,
wherein said support has a column-like shape extending in a longitudinal direction,
said support includes a plurality of cells arranged in a lengthwise direction and a lateral direction in a matrix,
said plurality of cells includes:
a plurality of membrane-formed cells each having both longitudinal ends open and having an inner surface on which said separation membrane is formed; and
an exhaust cell having both longitudinal ends closed,
said support has longitudinal end portions in both of which a side flow path is formed extending from an outer surface of said support to said exhaust cell,
said catalyst is arranged in said plurality of membrane-formed cells of said separation membrane complex,
said housing is connected to:
a source gas supplier that supplies a source gas containing a starting material to said separation membrane complex;
a permeated gas collector that collects a permeated gas in a mixed gas, the permeated gas having permeated said separation membrane, the mixed gas being produced by a chemical reaction of said starting material occurring in the presence of said catalyst;
a non-permeated gas collector that collects a non-permeated gas in said mixed gas, the non-permeated gas having not permeated said separation membrane; and
a sweep gas supplier that supplies a sweep gas,
said source gas is supplied to one longitudinal end face of said separation membrane complex,
said sweep gas is supplied to said side flow path that is open into the outer surface of said support, and
A/C is greater than or equal to 1 and less than or equal to 50, and B/C is greater than or equal to 0.5 and less than or equal to 20,
where A is a sum of cross-sectional areas of every one of said plurality of membrane-formed cells perpendicular to the longitudinal direction;
B is a sum of cross-sectional areas of every one of said exhaust cell perpendicular to the longitudinal direction; and
C is a sum of opening areas of every one of said side flow path that is located in one of the longitudinal end portions on the outer surface of said support.
